(19) United States
(12) Patent Application Publication
(10) Pub. No.: US 2013/0057526 A1
(43) Pub. Date: Mar. 7, 2013

(54) GENERATING DEVICE, DISPLAY DEVICE, PLAYBACK DEVICE, GLASSES

(71) Applicants: Wataru Ikeda, Osaka (JP); Tomoki Ogawa, Osaka (JP); Hiroshi Yahata, Osaka (JP)

(72) Inventors: Wataru Ikeda, Osaka (JP); Tomoki Ogawa, Osaka (JP); Hiroshi Yahata, Osaka (JP)

(21) Appl. No.: 13/697,850

(22) PCT Filed: Mar. 16, 2012
(86) PCT No.: PCT/JP2012/001852

§ 371 Date: Nov. 14, 2012

(30) Foreign Application Priority Data
Mar. 18, 2011 (JP) 2011-060212

(51) Int. Cl. G06T 15/00

(52) U.S. Cl. 345/204

(57) ABSTRACT

A display device is provided. Negative image generating units 4a and 4b generate negative images that negate normal images. The time-sharing processing unit 5 display negative images and normal images by time sharing. The negative images and normal images are displayed by time sharing in each of display periods which are obtained by dividing a frame period of an image signal. For each pair of a pixel included in the negative image and a pixel included in the normal image that correspond to each other, a luminance of a pixel in the negative image is set to a value greater than a difference obtained by subtracting a luminance of a corresponding pixel in the normal image from a maximum value in a range of luminance values that can be taken by each pixel.

### TECHNICAL FIELD

The present invention relates to a technology for synchronizing a display device and glasses.

### BACKGROUND ART

The technology for synchronizing a display device and glasses refers to a technology for switching between allowance and prohibition of image display to the user, by synchronizing a timing for displaying an original image on the display device with an open/close status of the shutters of the glasses. This structure realizes a multi-view mode and a multi-user mode. In the multi-view mode, displaying each of views constituting a stereoscopic viewing and a view constituting a 2D viewing are realized independently of each other. More specifically, displaying a left view and displaying a right view are realized. In the multi-user mode, a plurality of images to be viewed by respective users are provided independently of each other.

Also, a display switching makes it possible to switch between images to be displayed during each of display periods that are obtained by dividing one frame period into four or six periods.

For synchronization with the glasses, a conventional technology using infrared light has been developed, as well as a technology using Bluetooth™ recently, thus making it possible to perform a synchronization control in smaller units.

### CITATION LIST

### Patent Literature

### Patent Literature 1:

Japanese Patent No. 3935507

### SUMMARY OF INVENTION

### Technical Problem

A stereoscopic image displayed on a display device supporting the multi-view mode is suited for viewing with the glasses worn by the viewer, but offends a user who is not wearing the glasses since the image displayed on the screen is blurred horizontally. Thus it can be said that conventional display devices supporting the multi-view mode have not had sufficient consideration to users who do not wear the glasses.

This also applies to the multi-user mode. That is to say, when a user not wearing the glasses view the screen of a display device, the image displayed on the screen is an overlaid image generated by overlaying images for two or more users together, and the user is offended by the image that makes no sense to him/her.

The above-described technical problem is considered to occur under the condition where a display device supporting the multi-view mode performs a stereoscopic display. The case was selected as a typical case that is useful in explaining the technical problem of the present application. However, the technical problem of the present application is not limited to the case where a display device supporting the multi-view mode performs a stereoscopic display. The technical problem of the present application is to eliminate all possible visual problems that may occur when images of a certain type are displayed in turns by time sharing, and it is an unavoidable technical obstacle that one having ordinary skill in the art is to face in the near future when he/she attempts to put the above technology into practical use.

It is therefore an object of the present invention to provide a generating device that generates images that do not offend a user not wearing glasses.

### Solution to Problem

The above object is fulfilled by a generating device for generating images to be viewed by a user wearing glasses, comprising: an obtaining unit configured to obtain a normal image; and a generating unit configured to generate a negative image that negates the obtained normal image, wherein the glasses, when worn by the user, allow the user to view one or more of a plurality of images displayed by a time sharing in a frame period of an image signal, the normal image and the negative image are displayed by the time sharing, and for each pair of a pixel included in the negative image and a pixel included in the normal image that correspond to each other, a luminance of a pixel in the negative image is set to a value greater than a difference obtained by subtracting a luminance of a corresponding pixel in the normal image from a maximum value in a range of luminance values that can be taken by each pixel.

### Advantageous Effects of Invention

In the above-described structure, improvements have been added to the display method in the display device and the method of controlling the shutter-type glasses, and a normal image and a negative image that negates the normal image are displayed alternatively at a high speed, thereby different images are provided to a user depending on whether the user is wearing the glasses or not, and the above-mentioned problem is solved.

### BRIEF DESCRIPTION OF DRAWINGS

FIG. 1 illustrates a home theater system which includes a recording medium, a playback device, a display device and shutter-type glasses.

FIG. 2 illustrates one example of viewing the left-eye and right-eye images through the active-shutter-type glasses 103.

FIG. 3 illustrates a set of a left-eye image and a negative image and an overlaid image which is provided by displaying these images by time sharing.

FIG. 4 illustrates the internal structure of the display device in Embodiment 1.

FIG. 5 illustrates synchronization between the shutter-type glasses and the sync signal and the time-sharing display realized by the time-sharing processing unit, in the pattern 1.

FIG. 6 illustrates synchronization between the shutter-type glasses and the sync signal and the time-sharing display realized by the time-sharing processing unit, in the pattern 2.

FIG. 7 illustrates synchronization between the shutter-type glasses and the sync signal and the time-sharing display realized by the time-sharing processing unit, in the pattern 3.

FIG. 8 illustrates synchronization between the shutter-type glasses and the sync signal and the time-sharing display realized by the time-sharing processing unit, in the pattern 4.

FIG. 9 illustrates synchronization between the shutter-type glasses and the sync signal and the time-sharing display realized by the time-sharing processing unit, in the pattern 5.

FIG. 10 illustrates the internal structure of the negative image generating units 4a and 4b.

FIG. 11 illustrates the principle in calculating the inverse values of Y, Cr, and Cb.

FIGS. 12A and 12B illustrate a theoretical change of the brightness on the screen relative to the data in the numeral range from 0 to 255, and an actual change of the brightness on the screen.

FIGS. 13A to 13C illustrate, in association with each other, a theoretical setting of a negative image, an actual negative image, and negative image after measures have been taken.

FIG. 14 illustrates a case where, based on a straight line representing the luminance change when the luminance of the normal image changes within the range from 0 to 255, the luminance of the negative image is changed as an overshoot to some degree.

FIG. 15 is a main flowchart showing the processing procedure of the display device.

FIG. 16 illustrates the internal structure of the negative image generating units 4a and 4b in Embodiment 2.

FIG. 17 illustrates a visual effect produced by a partial negation of the normal image.

FIGS. 18A and 18B illustrate, in the form of equation “A+B=C”, a normal image, a negative image, and an overlaid image that is obtained by the time-sharing display.

FIG. 19 illustrates the internal structure of the playback device and the display device in which an improvement unique to Embodiment 3 has been added.

FIG. 20 is a flowchart showing the procedure for initializing the display device.

FIG. 21 illustrates the internal structure of the playback device in Embodiment 4.

FIG. 22 illustrates the internal structure of the playback device in Embodiment 5.

FIG. 23 illustrates the internal structure of the display device in Embodiment 5.

FIG. 24 illustrates the internal structure of the shutter-type glasses in Embodiment 5.

FIG. 25 illustrates a time-sharing display of an image with a subtitle and an image without a subtitle.

FIG. 26 illustrates a time-sharing display of an image with a subtitle and an audio in a specific language.

FIG. 27 illustrates the internal structure of the playback device in Embodiment 6.

FIG. 28 illustrates the internal structure of the display device and shutter-type glasses in Embodiment 6.

FIG. 29 illustrates an example of displaying where normal images and negative images of image A are displayed in sequence in accordance with a code sequence.

FIGS. 30A to 30D illustrate use cases of Embodiment 6 as supplemental description of the structural elements of Embodiment 6.

FIGS. 31A and 31B illustrate the concept of reducing errors by expanding the bit width.

### DESCRIPTION OF EMBODIMENTS

The invention of a generating device and a display device provided with means for solving the above problem can be implemented as a television. The invention of shutter-type glasses can be implemented as shutter-type glasses used to view a stereoscopic image on this television. The invention of a playback device can be implemented as a player for playing back a package medium. The invention of an integrated circuit can be implemented as a system LSI in any of the above devices. The invention of a program can be implemented as an executable-format program that is recorded on a computer-readable recording medium, and installed in this form in any of the above devices.

### Embodiment 1

The present embodiment provides generating devices supporting the multi-view mode and the multi-user mode which do not give an unpleasant feeling to a user even if the user sees the screen of the display device without wearing glasses.

That is to say, when a user not wearing glasses sees a stereoscopic image displayed on a conventional multi-view-supporting display device, the user sees the displayed images for two or more view points, as overlapping images. Such a screen displaying overlapping images is not appropriate to display a message that urges a user to wear the glasses. When such a display device is displayed in the shop, the device does not appeal to the viewers, due to the overlapping images that give an unpleasant feeling to them. The present embodiment provides a solution to the problem.

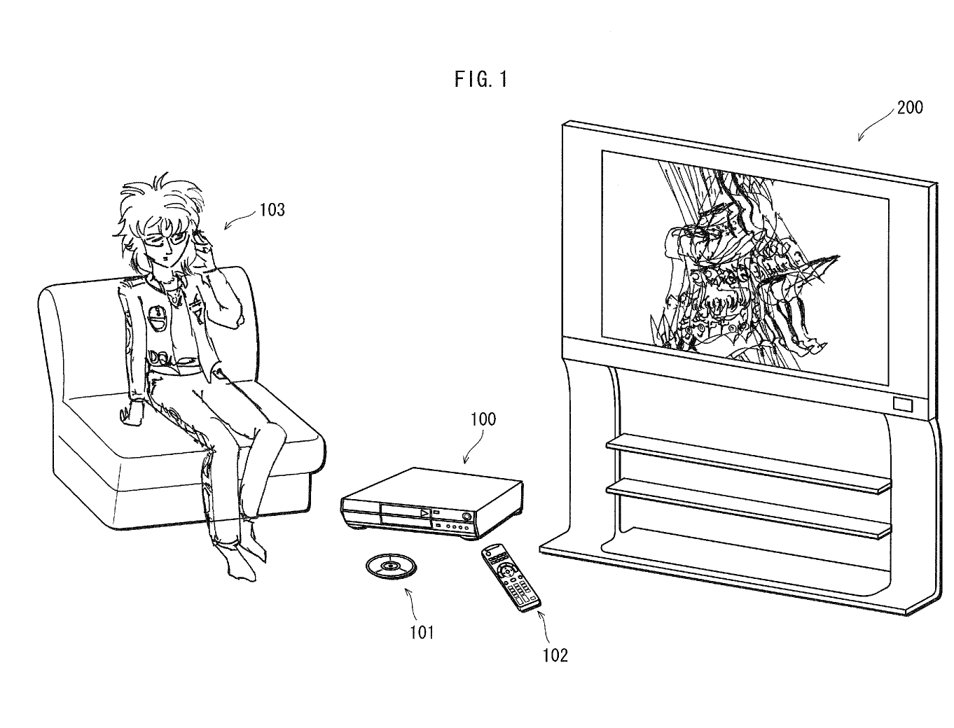

FIG. 1 illustrates a home theater system which includes a playback device, a display device and shutter-type glasses. As illustrated in FIG. 1, the home theater system includes a playback device 100, an optical disc 101, a remote control 102, active-shutter-type glasses 103, and a display device 200, and is provided for use by a user.

The playback device 100, connected with the display device 200, plays back a content recorded on the optical disc 101.

The optical disc 101 supplies, for example, movies to the above home theater system.

The remote control 102 is a device for receiving operations made by the user toward a hierarchical GUI. To receive such operations, the remote control 102 is provided with: a menu key for calling a menu representing the GUI; arrow keys for moving the focus among GUI parts constituting the menu; an enter key for confirming a GUI part of the menu; a return key for returning from lower parts to higher parts in the hierarchy of the menu; and numeric keys.

The active-shutter-type glasses 103 close one of the right-eye and left-eye shutters and open the other in each of a plurality of display periods that are obtained by dividing a frame period. This structure creates stereoscopic images. In the left-eye display period, the right-eye shutter is set to a closed state. In the right-eye display period, the left-eye shutter is set to a closed state. The shutter-type glasses have a wireless communication function, and can transmit information indicating the remaining amount of an embedded battery to the display device 200 upon request therefrom.

The display device 200 displays stereoscopic images of movies. During display of a stereoscopic image, the display device 200 displays image data of two or more view-points that constitute the stereoscopic image in each of the plurality of display periods which are obtained by dividing a frame period. When a user not wearing the shutter-type glasses sees the screen of the display device 200, the user sees the image data of two or more view-points (in FIG. 1, the left-eye and right-eye images) in a state where they are overlaid with each other.

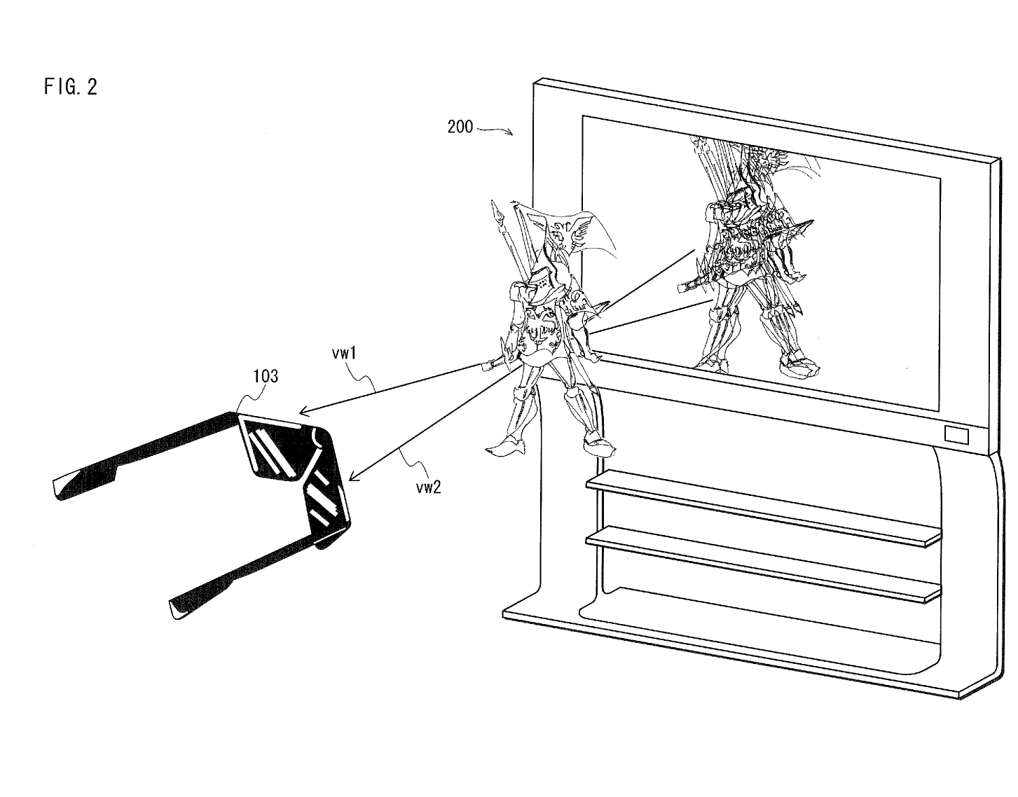

FIG. 2 illustrates one example of viewing the left-eye and right-eye images through the active-shutter-type glasses 103. A line of sight vw1 represents reception of an image when the active-shutter-type glasses 103 block light transmission to the right eye. A line of sight vw2 represents reception of an image when the active-shutter-type glasses 103 block light transmission to the left eye. The line of sight vw1 allows the viewer to receive the left-eye image. Also, the line of sight vw2 allows the viewer to receive the right-eye image. By wearing the active-shutter-type glasses 103, the user alternately views the left-eye and right-eye images, and the stereoscopic image is played back. FIG. 2 illustrates that a stereoscopic image appears at the position where the two lines of sight intersect.

### Embodiment 1

As illustrated in FIG. 2, the image displayed on the screen of the display device 200 is unwatchable without wearing the shutter-type glasses since it is based on the assumption that it is viewed through the shutter-type glasses. This problem taken into account, Embodiment 1 provides a negative image for each of the left-eye and right-eye images, and plays back the negative images in the same ratio as the left-eye and right-eye images so that either the left-eye image or the right-eye image cannot be viewed when the image is viewed without wearing the shutter-type glasses.

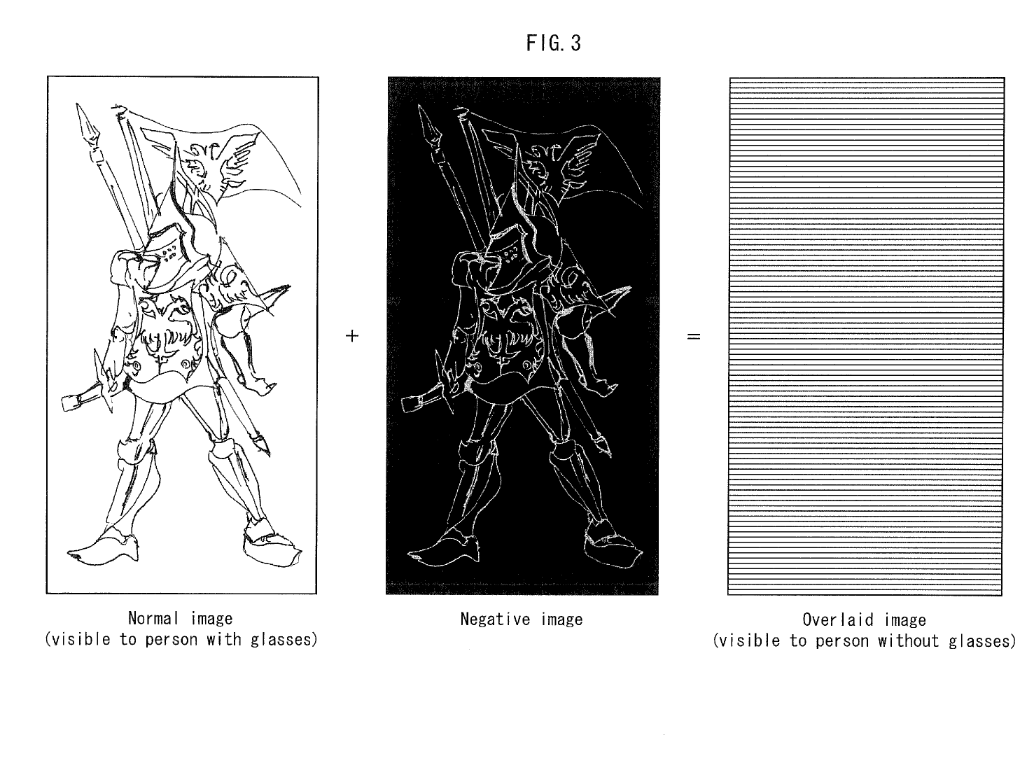

FIG. 3 illustrates a set of a left-eye image and a negative image and an overlaid image which is provided by displaying these images by time sharing. In FIG. 3, the normal image of a left-eye image is provided on the left-hand side of the + sign. Also, the negative image of the left-eye image is provided on the right-hand side of the + sign. Furthermore, the overlaid image, which is obtained by displaying the normal image and the negative image by time sharing, is provided on the right-hand side of the = sign. Pixels constituting the negative image (image B) negate pixels of the normal image (image A), and thus by displaying these images, the luminance of the image pattern that is present in the image A is uniformed. Such a time-sharing display is performed on each of the left-eye and right-eye images, so that the image pattern of the normal image cannot be seen when the image is viewed without wearing the shutter-type glasses. In this way, the present embodiment displays the normal image and the negative image by time sharing to produce an effect that a person not wearing the shutter-type glasses can only see an image having no grayscale and cannot recognize the normal image, so that a person wearing the shutter-type glasses can view the normal image, while the person not wearing the shutter-type glasses cannot recognizing an image. In contrast, the present embodiment allows a person wearing the shutter-type glasses to see the normal image by the shutter function of the shutter-type glasses, and prevents him/her from seeing the negative image, thereby enabling only persons wearing the shutter-type glasses to view the normal image.

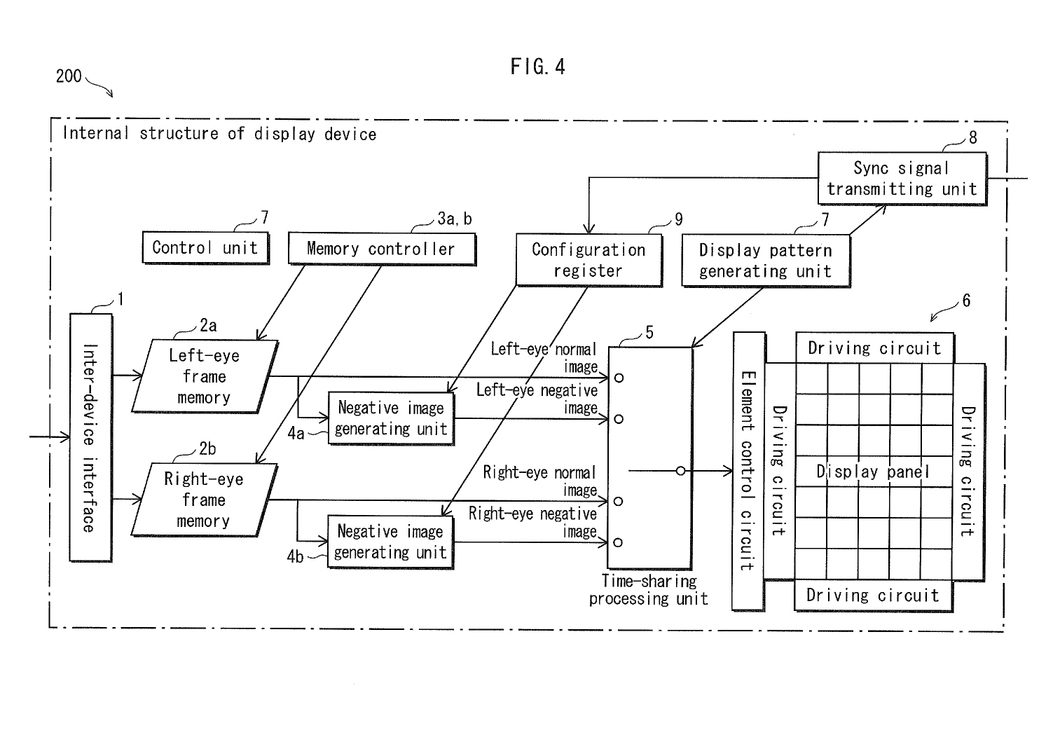

FIG. 4 illustrates the internal structure of the display device having the above improvement. FIG. 4 illustrates the internal structure of the display device in Embodiment 1. As illustrated in FIG. 4, the display device includes an inter-device interface 1, a left-eye frame memory 2a, a right-eye frame memory 2b, a memory controller 3a, a memory controller 3b, a negative image generating unit 4a, a negative image generating unit 4b, a time-sharing processing unit 5, a display circuit 6, a configuration register 7, a display pattern generating unit 8, and a sync signal transmitting unit 9.

One characteristic of the structure illustrated in FIG. 4 is that it includes a plurality of lines each of which includes a frame memory and a negative image generating unit, and the display circuit 6 receives an output from one of the plurality of lines. The plurality of lines are provided to support the multi-view mode and the multi-user mode. The present device is supposed to process the left-eye and right-eye images, and thus its internal structure includes pairs of structural elements that have the same structure and are used differently: one used for the left-eye; and the other used for the right-eye. Such structural elements that have the same structure and are used for the left-eye and the right-eye are distinguished from the other structural elements in that they are assigned, as the reference signs, the same number and alphabets “a” and “b”. In the following, with regard to the structural elements that have the same structure and are used for the left-eye and the right-eye, merely a process common to them is explained since the structures are the same.

In FIG. 4, the number of lines which each includes a frame memory and a negative image generating unit is “2”. This is the minimum structure for supporting the two views (left-eye and right-eye) and two users (user A wearing shutter-type glasses A and user B wearing shutter-type glasses B). These constitutional elements of the display device will be described in the following.

The inter-device interface 1 transfers decoded video or audio via, for example, a composite cable, a component cable or a multimedia cable conforming to the HDMI standard. In particular, the HDMI allows for addition of various types of property information to the video.

The left-eye frame memory 2a stores, for each frame, left-eye image data that is transferred thereto via the inter-device interface 1.

The right-eye frame memory 2b stores, for each frame, right-eye image data that is transferred thereto via the inter-device interface 1.

The memory controllers 3a and 3b generate read-destination addresses for the frame memories 2a and 2b, and instruct the frame memories 2a and 2b to read data from the read-destination addresses.

The negative image generating units 4a and 4b generate negative images by transforming pixel values of the normal images by using a predetermined function, and output the generated negative images to the display circuit 6.

The time-sharing processing unit 5, in each of the plurality of display periods that are obtained by dividing a frame period, causes normal images to be read and outputs selectively any of the left-eye normal image, left-eye negative image, right-eye normal image, and right-eye negative image, to the display circuit 6.

The display circuit 6 includes: a display panel in which a plurality of light-emitting elements such as organic EL elements, liquid crystal elements, or plasma elements are arranged in a matrix; driving circuits attached to four sides of the display panel; and an element control circuit, and the display circuit 6 performs turning on and off of the light-emitting elements in accordance with the pixels constituting the image data stored in the left-eye frame memories 2a and 2b.

The configuration register 7 is a nonvolatile memory for storing information such as the screen size, screen mode, manufacturer name, and model name.

The display pattern generating unit 8 generates an in-frame switching pattern which is a display pattern used to support the multi-view mode and the multi-user mode. The in-frame switching pattern defines which of a normal image and a negative image is to be displayed in each of the plurality of display periods that are obtained by dividing a frame period. When the multi-view mode is executed, the normal image is classified into a left-eye image L, a right-eye image R, and a 2D-only image 2D. When the multi-user mode is executed, the normal image is classified into an image A for the user A and an image B for the user B. When the number of divisions is “4”, four display periods are obtained in one frame. The four display periods are referred to as display periods 1 to 4, and either a normal image or a negative image is assigned to each of the display periods. The total number of normal images assigned to one frame must be the same as the total number of negative images to be assigned to one frame. Here, the normal image and negative image are to be displayed in each of the plurality of display periods that are obtained by dividing a frame period. Thus it is necessary to determine which normal image and which negative image are to be displayed in respective display periods that are each assigned to a combination of a view and a user, before the display periods arrive.

The sync signal transmitting unit 9 generates a sync signal in accordance with the in-frame switching pattern, and transmits the generated sync signal. The transmitted sync signal defines how the statuses of the left-eye and right-eye shutters of shutter-type glasses of each user are set in each display period of one frame. Basically the multi-view mode involves a single user, and in the multi-view mode, the status of the shutters of the shutter-type glasses worn by the user is changed for each of the left eye and the right eye. The multi-user mode involves a plurality of users, and in the multi-user mode, the setting of the opened/closed status is common to the left eye and the right eye. That is to say, in the multi-user mode, the sync signal is transmitted to change, for each user, the statuses of the left-eye and right-eye shutters of the shutter-type glasses worn by each user. With such an opened/closed status control, each user can see images in some display periods and cannot see images in other display periods among the plurality of display periods that are obtained by dividing a frame period. To support the multi-user mode, the sync signal transmitting unit 9 transmits a sync signal attached with a shutter-type glasses identifier. The shutter-type glasses identifier identifies shutter-type glasses to which the sync signal is to be applied. The control unit of the shutter-type glasses warn by each of the plurality of users performs a control such that it obtains merely sync signals attached with the identifier of its own device and disregards the rest. With this control, the plurality of users can view different images. This completes the description of the internal structure of the display device.

There are various patterns of assigning the display periods, which are obtained by dividing a frame period, to the plurality of views in the multi-view mode and to the plurality of users in the multi-user mode. Here, five typical patterns (patterns 1 to 5) are chosen, and description is given of how the time-sharing processing unit 5 and the sync signal transmitting unit 9 perform the processing for each of the five patterns. In the following description, images to be viewed by the users A and B in the multi-user mode are referred to as images A and B, respectively. Also, when the multi-view mode is executed, the left-eye image is called “L”, the right-eye image is called “R”, and an image prepared for a 2D playback is called “2D”.

—Pattern 1

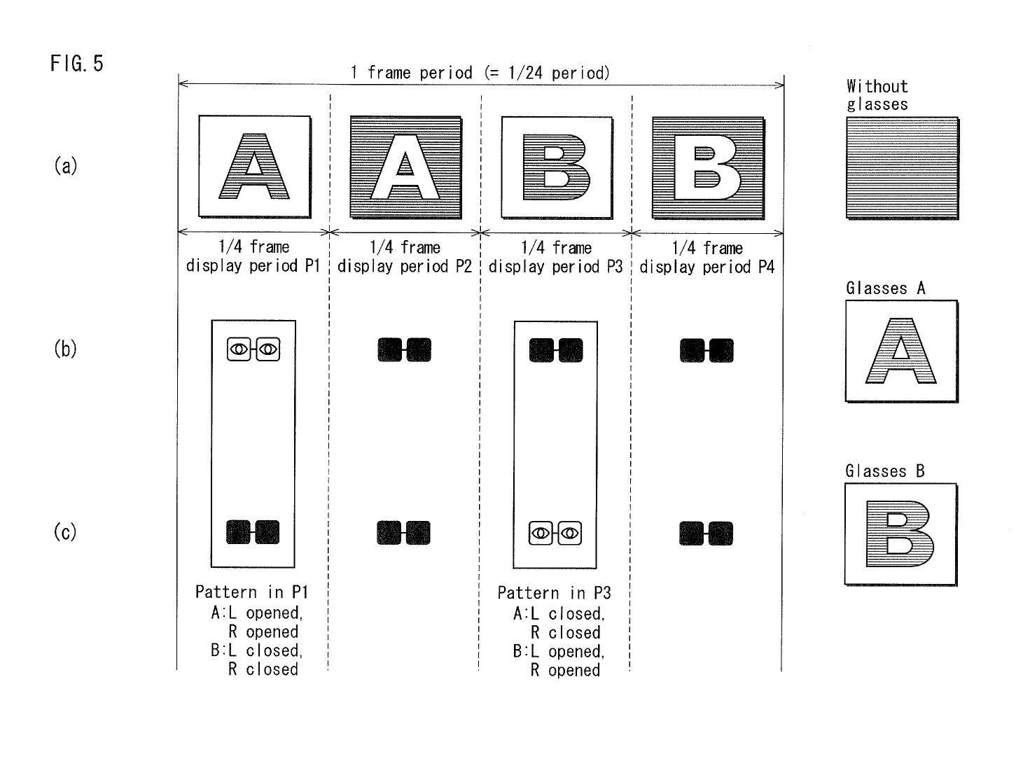

In the pattern 1, each of the plurality of users views the images A and B. FIG. 5 illustrates synchronization between the shutter-type glasses and the sync signal and the time-sharing display realized by the time-sharing processing unit, in the pattern 1. FIG. 5 portion (a) indicates that normal image A, negative image A, normal image B, and negative image B are displayed in sequence in the time-sharing manner. When these normal images and negative images are displayed simultaneously and overlaid with each other, the images A and B are totally erased. FIG. 5 portion (b) indicates sync signals transmitted by the sync signal transmitting unit. FIG. 5 portion (b) indicates that the shutter is opened only during the first ¼-frame display period, and is closed during the other display periods. With this control, the user wearing the shutter-type glasses A sees only the image A.

FIG. 5 portion (c) indicates the sync control performed on the shutter-type glasses B. FIG. 5 portion (c) indicates that the shutter is opened only during the third ¼-frame display period, and is closed during the other display periods. This allows only the image B to be viewed.

A person who does not wear shutter-type glasses sees all of the images at the same to recognize an image without grayscale since the normal images A and B and the negative images A and B are overlaid with each other by the time-sharing display. The shutter of the shutter-type glasses A is opened only when the normal image A is displayed, and is closed for the rest of the periods. A person who wears the shutter-type glasses A sees only the normal image A and does not see the other images, and thus does not see the negative image A. Accordingly, the person wearing the shutter-type glasses A can recognize the normal image A.

The shutter of the shutter-type glasses B is opened only when the normal image B is displayed, and is closed for the rest of the periods. A person who wears the shutter-type glasses B sees only the normal image B and does not see the other images, and thus does not see the negative image B and can recognize the normal image B.

During the display period P1 illustrated in FIG. 5, the user wearing the shutter-type glasses A needs to view the image A, and thus the sync signal transmitting unit 9 generates a sync signal that sets the left eye and right eye of the user A to the opened state and closed state, respectively, and sets the left eye and right eye of the user B to the closed state and opened state, respectively. During the display period P3, the sync signal transmitting unit 9 generates a pattern in which the left eye and right eye of the user A are in the closed state, and the left eye and right eye of the user B are in the opened state. A sync signal indicating this pattern is transmitted before the start of the display period arrives, and images are changed in this pattern.

—Pattern 2

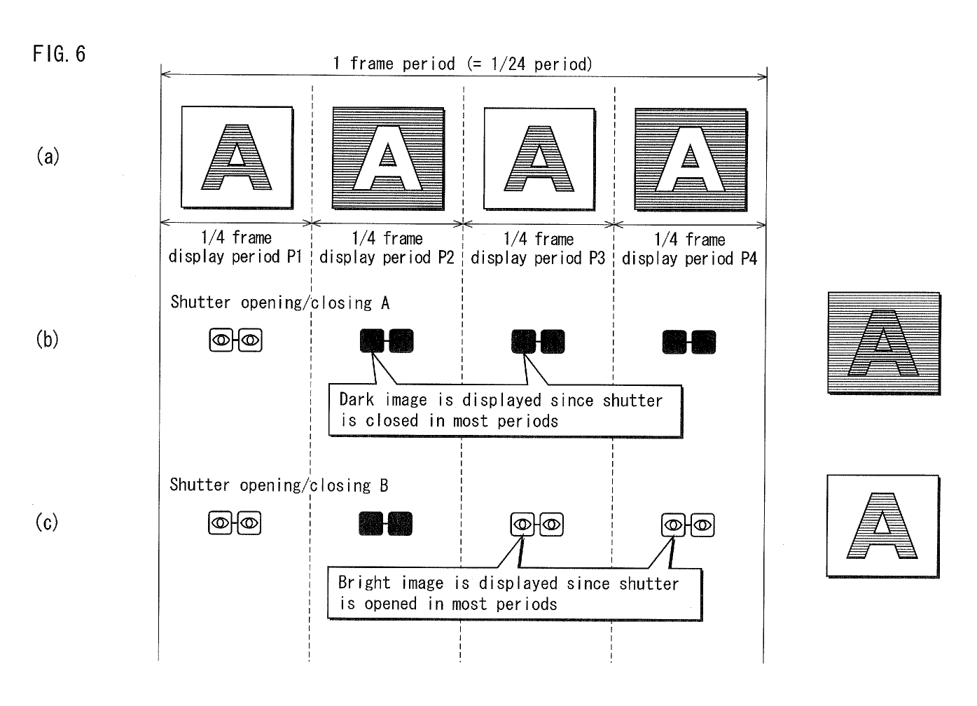

In the pattern 2, a brightness adjustment is executed. FIG. 6 portion (a) indicates that normal image A, negative image A, normal image A, and negative image A are displayed in sequence in the time-sharing manner. When these normal images and negative images are displayed simultaneously, the images are totally erased. FIG. 6 portion (b) indicates sync signals transmitted by the sync signal transmitting unit. FIG. 6 portion (b) indicates that the shutter is opened only during the first ¼-frame display period, and is closed during the other display periods. With this control, the user wearing the shutter-type glasses A sees only an image with low brightness.

FIG. 6 portion (c) indicates the sync control performed on the shutter-type glasses B. FIG. 6 portion (c) indicates that the shutter is closed only during the second ¼-frame display period, and is opened during the other display periods. With this control, the user sees only an image with high brightness.

FIG. 6 portion (b) indicates that the shutter is opened only during the first ¼-frame display period, and is closed during the other display periods. With this structure, the shutter is closed during ¾ of the total frame display period, and thus the image is dark. In the example illustrated in FIG. 6, the shutter of the shutter-type glasses A is opened only when the normal image A is displayed, and is closed for the remaining period. However, not limited to this, the shutter may be opened when the normal image B and the negative image B are displayed, as well as when the normal image A is displayed. This structure produces not only an effect that eventually only the normal image A can be recognized since the normal image B and the negative image B are overlaid with each other, but also an effect that a brighter image can be viewed since the shutter is opened for a longer time period.

—Pattern 3

In the pattern 3, a user who does not wear the shutter-type glasses can see the image A, and a user wearing the shutter-type glasses can see the image B.

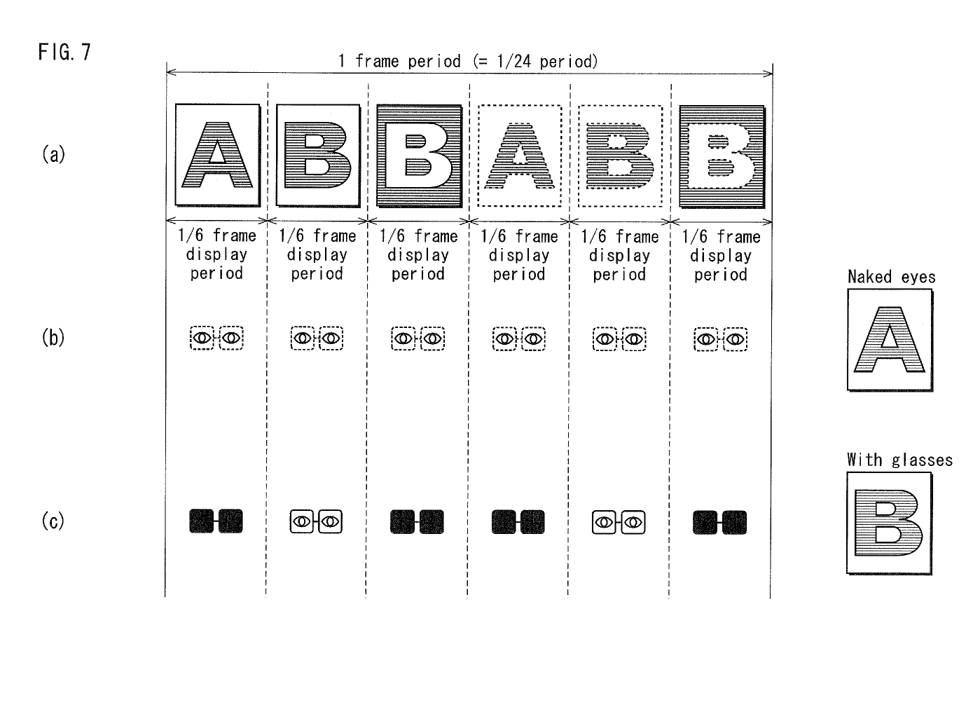

FIG. 7 illustrates the pattern 3 in which a user who does not wear the shutter-type glasses can see the image A, and a user wearing the shutter-type glasses can see the image B. FIG. 7 indicates that the following images are repeatedly displayed, with switching among them being performed at high speed: normal image A→normal image B→negative image B. FIG. 7 portion (a) indicates that the normal image A, normal image B, negative image B, normal image A, normal image B, and negative image B are displayed in sequence in the time-sharing manner respectively in the six ⅙ frame periods that are obtained by dividing one frame into six periods. FIG. 7 portion (b) indicates viewing in the state where the shutter-type glasses are not worn. In this viewing, the normal image B and negative image B are displayed simultaneously, thus the image B is totally erased and only the image A is seen. FIG. 7 portion (c) indicates the sync signal transmitted to the shutter-type glasses. FIG. 7 portion (c) indicates that the shutter is opened during the second and fifth ⅙-frame display periods, and is closed during the other display periods. With this control, the user wearing the shutter-type glasses B sees only the image B.

In this pattern, when the shutter-type glasses are not worn, only the normal image A can be recognized since the normal image B and negative image B are overlaid with each other and cannot be recognized. On the other hand, when the shutter-type glasses are worn, the normal image B can be seen since the shutter is opened at the timing when the normal image B is displayed.

—Pattern 4

In the pattern 4, a user wearing the shutter-type glasses can view a stereoscopic image, and a user not wearing the shutter-type glasses can see either a left-eye image and a right-eye image that constitute the stereoscopic image.

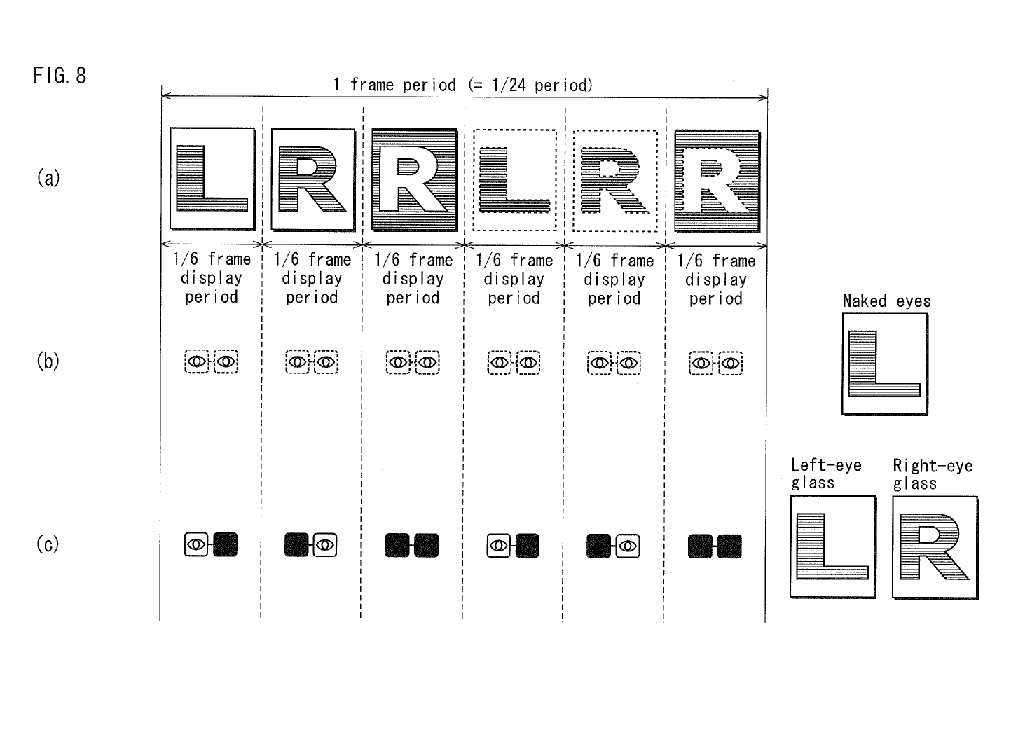

FIG. 8 illustrates a time-sharing display by the stereoscopic processing in the pattern 4. FIG. 8 portion (a) indicates that a left-eye normal image L, a right-eye normal image R, a left-eye negative image R, a left-eye normal image L, a right-eye normal image R, and a right-eye negative image R are displayed in sequence in the time-sharing manner respectively in the six ⅙ frame periods that are obtained by dividing one frame into six periods. FIG. 8 portion (b) indicates viewing in the state where the shutter-type glasses are not worn. In this viewing, the right-eye normal image and right-eye negative image are displayed simultaneously, thus the right-eye image R is totally erased and only the left-eye image L is seen. FIG. 8 portion (c) indicates that the left-eye shutter is opened during the first ⅙-frame display period, the right-eye shutter is opened during the second ⅙-frame display period, the left-eye shutter is opened during the fourth ⅙-frame display period, the right-eye shutter is opened during the fifth ⅙-frame display period, and the shutters are closed during the remaining ⅙-frame display periods, thus the user wearing the shutter-type glasses can view the normal image composed of the left-eye image L and the right-eye image R as a stereoscopic image.

In this example illustrated in FIG. 8, the following images are repeatedly displayed, with switching among them being performed at a high speed: normal image L→right-eye normal image→negative image R. With this structure, the user who does not wear the shutter-type glasses can recognize only the left-eye normal image as a 2D image. On the other hand, the user wearing the shutter-type glasses can view a 3D image composed of the left-eye normal image and the right-eye normal image since the left-eye shutter is opened when the left-eye normal image is displayed, and the right-eye shutter is opened when the right-eye normal image is displayed. This method of this case is effective when the 2D image that is viewed by the user not wearing the shutter-type glasses is the same as the left-eye image of the 3D image.

—Pattern 5

In the pattern 5, a user wearing the shutter-type glasses can view a stereoscopic image, and a user not wearing the shutter-type glasses can see a 2D image which is neither a left-eye image nor a right-eye image that constitute the stereoscopic image.

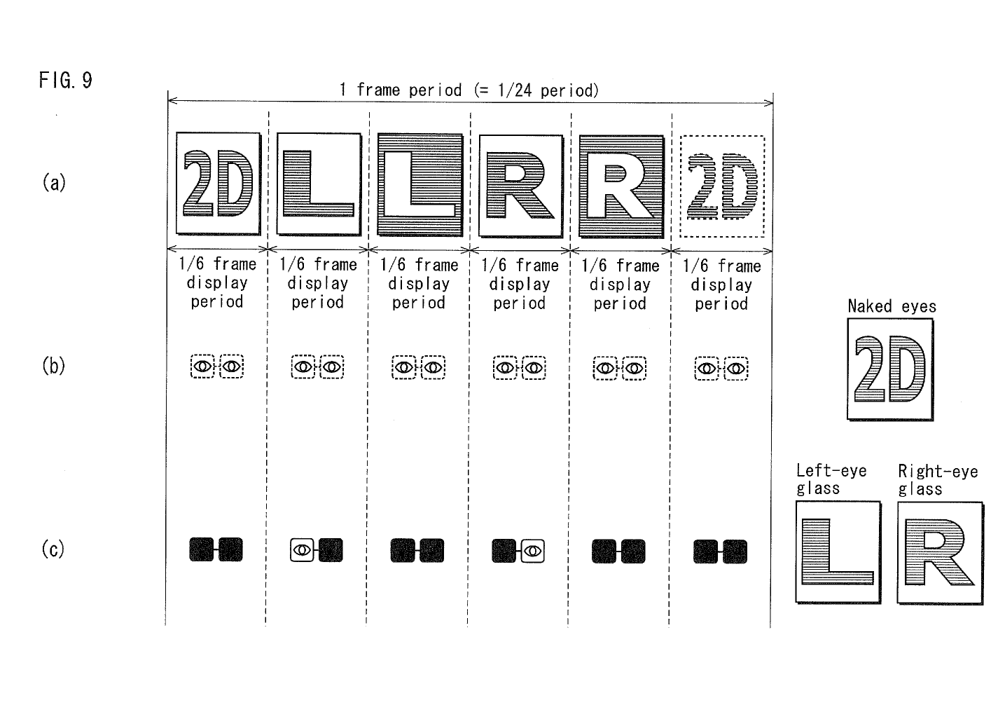

FIG. 9 portion (a) indicates that a 2D image, a left-eye normal image L, a left-eye negative image L, a right-eye normal image R, a right-eye negative image R, and a 2D image are displayed in sequence in the time-sharing manner respectively in the six ⅙ frame periods that are obtained by dividing one frame into six periods. FIG. 9 portion (b) indicates viewing in the state where the shutter-type glasses are not worn. In this viewing, the left-eye normal image, left-eye negative image, right-eye normal image, and right-eye negative image are displayed simultaneously, thus the left-eye image and the right-eye image are totally erased and only the 2D image is seen. FIG. 9 portion (c) indicates the sync signal transmitted to the shutter-type glasses. FIG. 9 portion (c) indicates that the left-eye shutter is opened during the second ⅙-frame display period, the right-eye shutter is opened during the fourth ⅙-frame display period, and the shutters are closed during the remaining ⅙-frame display periods. With the shutters being opened as such, the left-eye image and the right-eye image are displayed alternately, and thus the user wearing the shutter-type glasses can view a stereoscopic image.

In this example illustrated in FIG. 9, the following images are repeatedly displayed, with switching among them being performed at a high speed: normal image 2D→left-eye normal image→negative image L→right-eye normal image→negative image R. With this structure, the user who does not wear the shutter-type glasses can recognize only the normal image 2D since the left-eye normal image and the right-eye normal image are negated. On the other hand, the user wearing the shutter-type glasses can view a 3D image composed of the left-eye normal image and the right-eye normal image since the left-eye shutter is opened when the left-eye normal image is displayed, and the right-eye shutter is opened when the right-eye normal image is displayed.

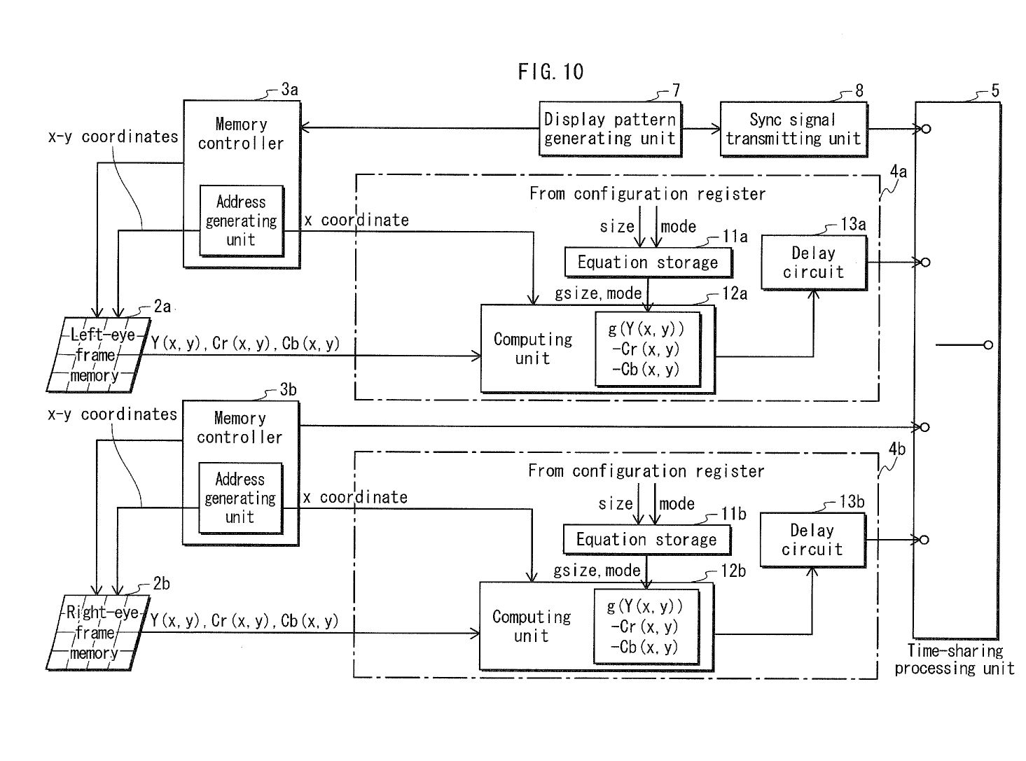

This completes the description of the display patterns. Among the structural elements illustrated in FIG. 4, the negative image generating units 4a and 4b constitute the core of the device and play an important role in particular in the present embodiment. In view of the importance thereof, the following describes the internal structure of the negative image generating units 4a and 4b in more detail. The negative image generating units 4a and 4b are devices for generating negative images and have an internal structure illustrated in FIG. 10. FIG. 10 illustrates the internal structure of the negative image generating units 4a and 4b. As illustrated in FIG. 10, the negative image generating units 4a and 4b include transformation equation storages 11a and 11b, computing units 12a and 12b, and delay circuits 13a and 13b. The present device is supposed to process the left-eye and right-eye images, and thus its internal structure includes pairs of structural elements that have the same structure and are used differently: one used for the left-eye; and the other used for the right-eye. Such structural elements that have the same structure and are used for the left-eye and the right-eye are distinguished from the other structural elements in that they are assigned, as the reference signs, the same number and alphabets “a” and “b”. In the following, with regard to the structural elements that have the same structure and are used for the left-eye and the right-eye, merely a process common to them is explained since the structures are the same.

<Transformation Equation Storages 11a and 11b>

The transformation equation storages 11a and 11b store a plurality of transformation equations. These transformation equations are associated with combinations of the size of the display device and the screen mode, and a transformation equation is extracted from the storages in correspondence with a combination of a current screen mode and a screen size. One model of one display device is provided in various screen sizes such as 50 inch, 42 inch and 37 inch. Accordingly, those screen sizes are associated uniquely with transformation equations. Also, for each of those screen sizes, an image can be displayed in various screen modes such as high-contrast mode, smooth mode, and movie mode. Thus the transformation equation storages 11a and 11b store equation codes or correction parameters that identify transformation equations that have different degrees and/or coefficients in correspondence with the respective screen modes. In the case where the display device itself holds the transformation equations, the producer of the display device, who grasps the property of the display device, store, in the nonvolatile memory, transformation equations whose degrees and/or coefficients differ depending on the property. Here, the transformation equations may be stored in the transformation equation storages 11a and 11b as follows: a data base of equation codes representing the respective transformation equations is stored; or a data base of degrees and coefficients of the transformation equations, as correction parameters, is stored.

<Computing Units 12a and 12b>

The computing units 12a and 12b transform luminance Y, red color difference Cr, and blue color difference Cb constituting a normal image to pixel value positions of a negative image. The red color difference Cr and blue color difference Cb are transformed to inverse values. The luminance Y is transformed to a pixel value of the negative image by using a transformation equation (g(Y)) or a correction parameter. The transformation equation g(Y) is specifically as follow: when a transformation equation related to the screen size of the display device 200 is represented as “g size”, and a transformation equation related to the current screen mode of the display device 200 is represented as “mode”, a luminance Y(x,y) located at a given X coordinate on the screen is transformed by the transformation equations “g size” and “mode”.

What is important in this transformation is how to negate the luminance Y, red color difference Cr, and blue color difference Cb that constitute the pixel values of the normal image. Since the basic principle of this process is important, it is explained in the following with reference to drawings specialized therefor. The following describes the basic principle of the process with reference to the drawings.

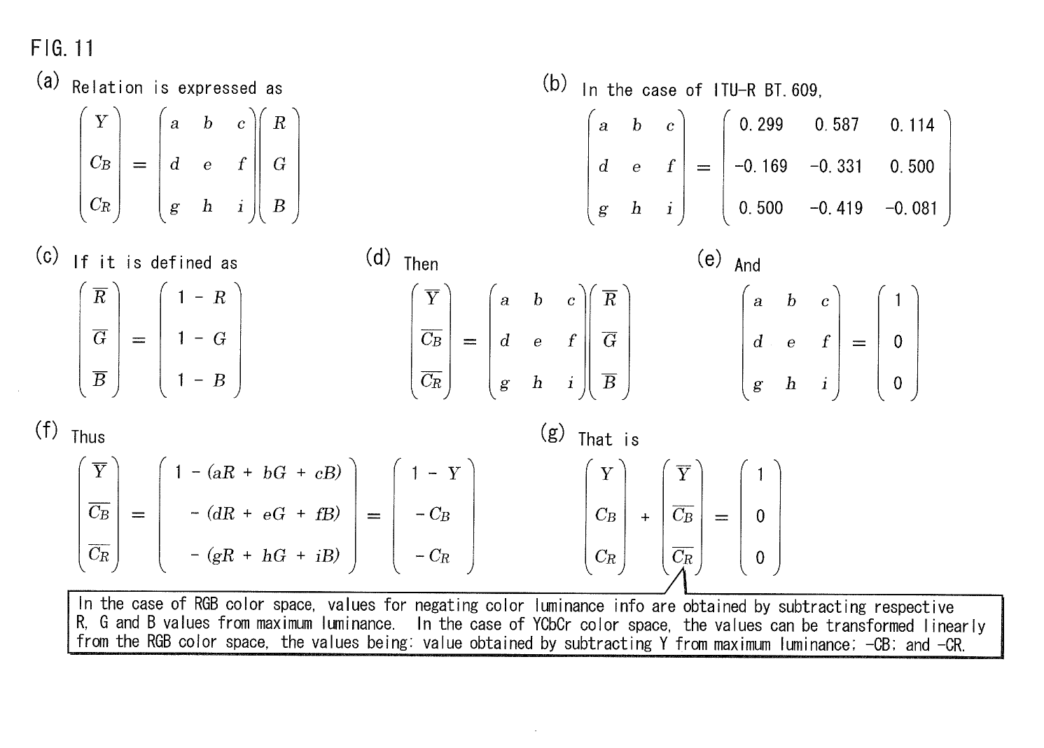

FIG. 11 illustrates the principle in calculating the inverse values of Y, Cr, and Cb. The portion (a) of FIG. 11 indicates a transformation matrix used for transforming R, G, and B to Y, Cr, and Cb. The transformation matrix is a 3×3 determinant with elements a, b, c, d, e, f, g, h, and i. The portion (b) indicates the values of the elements a, b, c, d, e, f, g, h, and i of the determinant. The portion (c) indicates the inverse value of elements R, G, and B. The inverse values are “1−R”, “1−G”, and “1−B”. The portion (d) indicates the inverse values of Y, Cr, and Cb and the inverse values of R, G, and B. In the portion (d), the inverse values of luminance Y, red color difference Cr, and blue color difference Cb are obtained by transforming the RGB values of pixels by using the transformation equation with elements a, b, c, d, e, f, g, h, and i. The portion (e) indicates the relationship between the elements a, b, c, d, e, f, g, h, and i of the determinant. The portions (f) and (g) indicate the inverse values of Y, Cr, and Cb and the relationship between a set of R, G, and B and a set of Y, Cr, and Cb. As FIG. 11 indicates, the sum of luminance Y and the inverse value thereof is 1, the sum of red color difference Cr and the inverse value thereof is 0, and the sum of blue color difference Cb and the inverse value thereof is 0.

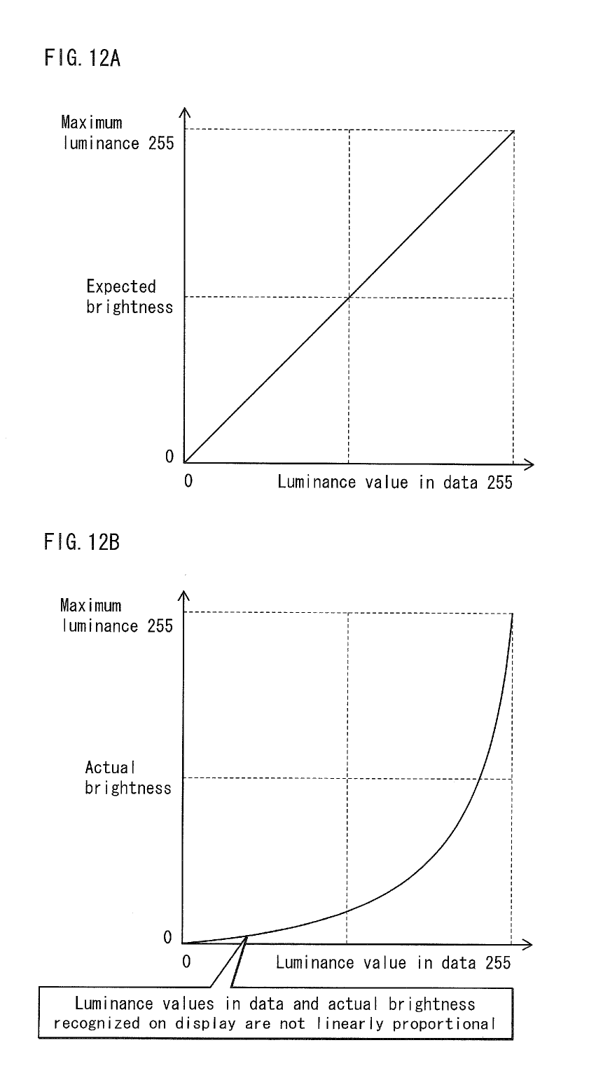

As understood from the portion (g) of FIG. 11, to negate a normal image by time sharing, the inverse values of luminance Y, red color difference Cr, and blue color difference Cb, which constitute the normal image, are obtained, and a negative image whose pixel value positions are the obtained inverse values is created. However, actual brightness of the pixels does not vary linearly relative to the brightness data. FIGS. 12A and 12B illustrate a theoretical change of the brightness on the screen relative to the data in the numeral range from 0 to 255, and an actual change of the brightness on the screen. FIG. 12A is a graph indicating a brightness change, wherein the horizontal axis represents the luminance value in the data ranging from 0 to 255, and the vertical axis represents the expected brightness. As illustrated in FIG. 12A, the ideal change of brightness is that the screen becomes brighter as the luminance increases. FIG. 12B is a graph indicating the actual brightness change. As understood from FIG. 12B, the actual brightness of the screen changes non-linearly as the luminance value in the data changes from 0 to 255.

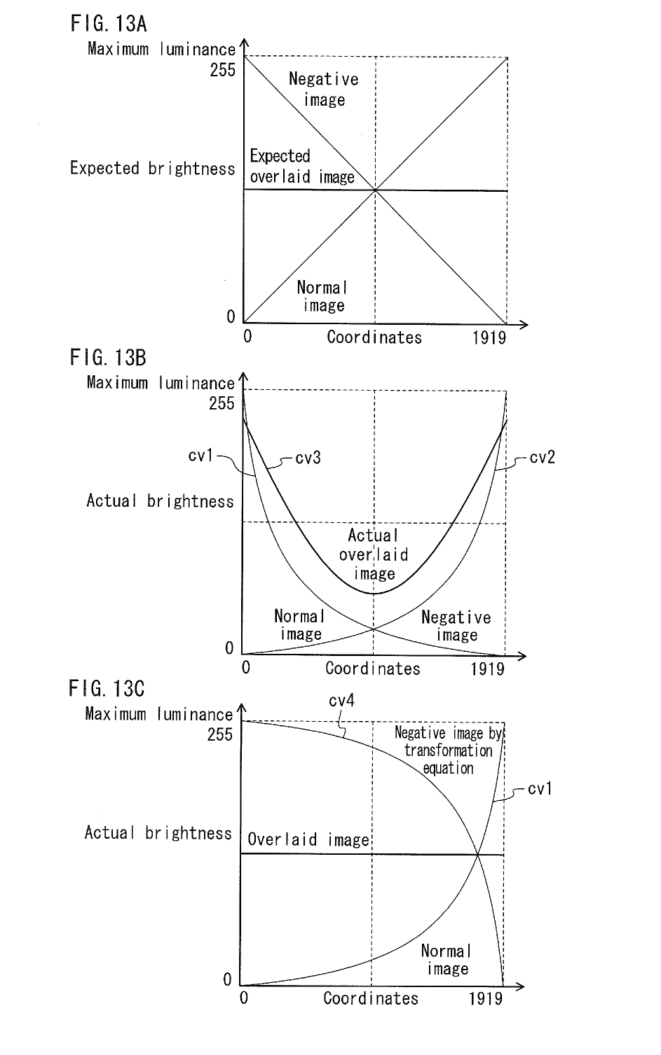

Here, a description is given of how to negate an image in the case where the screen has a resolution of 1920×1080, and a gradation is formed as the luminance increases from left to right on the screen. FIGS. 13A to 13C illustrate, in association with each other, a theoretical setting of a negative image, an actual negative image, and negative image after measures have been taken.

First, the following describes a theoretical luminance change, namely, how to change the luminance of the negative image depending on the coordinate value ranging from 0 to 1919 on the screen. FIG. 13A illustrates expected luminance changes in the original and negative images relative to the coordinate values. In FIG. 13A, it is set such that the sum of the luminance values in the normal image and the negative image becomes 255. For example, when the luminance value of the normal image is 0, the luminance value of the negative image is set to 255, when the luminance value of the normal image is 128, the luminance value of the negative image is set to 127, and when the luminance value of the normal image is 255, the luminance value of the negative image is set to 0. In this case, the luminance value of the normal image increases monotonously relative to the coordinate value, and the luminance value of the negative image decreases monotonously relative to the coordinate value. This represents an expectation that the brightness of the overlaid image on the screen is constant relative to the coordinate value.

However, in the actuality, the luminance values of the original and negative images change relative to the coordinate value as illustrated in FIG. 13B, not as illustrated in FIG. 13A. That is to say, FIG. 13A indicates a theoretical change, while FIG. 13B indicates an actual change of the luminance values of the original and negative images change relative to the coordinate value. As illustrated in FIG. 13B, the luminance value of the normal image increases in a curve relative to the coordinate value on the screen as represented by a curve cv2, and the luminance value of the negative image decreases in a curve relative to the coordinate value as represented by a curve cv1. As a result, the brightness of the overlaid image, which is displayed when the original and negative images are displayed by time sharing, changes in a U-shaped curve, not changing constantly, as represented by a curve cv3 in the drawing. In this way, the actual brightness of the overlaid image, which is displayed when the original and negative images are displayed by time sharing, is not constant, and when the normal image and the negative image are displayed alternately, a dim figure of the normal image appears, and the image pattern of the normal image can be recognized to a certain extent.

For the overlaid image, which is displayed when the original and negative images are displayed by time sharing, to be recognized without grayscale over the entire screen, it is necessary to set the luminance of the negative image so that, at a given coordinate of the normal image, the result of overlaying the following (a) and (b) is constant: (a) the brightness which is obtained by taking account of the visual property of human being and correction of the luminance by the display device; and (b) the brightness of the negative image at the same coordinate. Also, the luminance value of the negative image needs to be deviated toward higher value of luminance. FIG. 13C illustrates an ideal form of the luminance change in the negative image. In FIG. 13B, the curve cv3 indicates the change of the pixel in the normal image. With regard to this pixel change in the normal image, a change, which is symmetric to the change of the normal image with respect to the center of the vertical axis, is generated as the negative image that is represented by a curve cv4. When a negative image whose change is line-symmetric to the change of the normal image is prepared, and the normal image and the negative image are displayed by time sharing, the brightness of the overlaid image becomes constant.

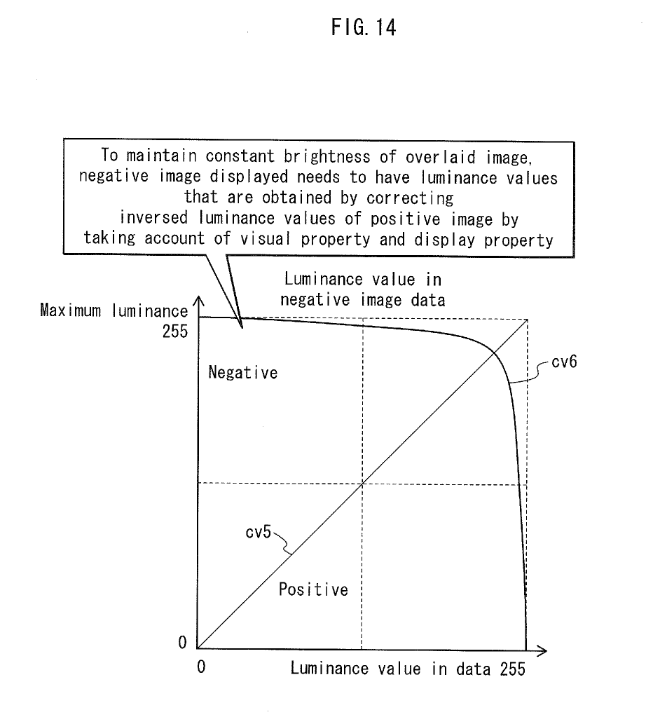

More specifically, the luminance of the normal image is changed as illustrated in FIG. 14. FIG. 14 illustrates a case where, based on a straight line representing the luminance change when the luminance of the normal image changes within the range from 0 to 255, the luminance of the negative image is changed as an overshoot to some degree. This somewhat overshoot change is generated by setting a value, which is greater than a difference between the maximum luminance and a luminance value of the normal image, to a corresponding luminance value of the negative image. The curve illustrated in FIG. 14 varies greatly depending on the screen property of the display device. The display device adjusts the signal values and the actual amounts of energy given to dots, in accordance with the panel property or the mode. This is not represented by a linear function between the signal values and the amounts of energy, and even if it is linear-proportional, the human eyes may not necessarily respond to it linearly. Accordingly, it is desirable that this curve is empirically derived.

The image pattern of the normal image can be negated by a negative image that is generated by setting a value, which is greater than a difference between the maximum luminance and a luminance value of the normal image, to a corresponding luminance value of the negative image. The change of the negative image may take any form as far as it satisfies the condition that a value thereof is greater than a difference between the maximum luminance and a luminance value of the normal image, and the change of the negative image can be defined by an n-th dimensional function of the luminance. The definition of the somewhat overshoot change of the luminance of the negative image varies depending on the screen mode and the screen size of the display device. Accordingly, in the present embodiment, a plurality of transformation equations, which have different degrees and coefficients and are represented by the n-th dimensional function, are stored in advance. Furthermore, the respective combinations of a screen mode and a screen size are assigned to the plurality of transformation equations, thereby enabling the display device to adapt to the current screen mode and size.

<Delay Circuits 13a and 13b>

The delay circuits 13a and 13b delay the transfers from the computing units 12a and 12b to the time-sharing processing unit 5 by a predetermined time.

This completes the description of the internal structure of the negative image generating units 4a and 4b. The display device of the present embodiment can be manufactured industrially by using hardware integrated circuits such as ASICs (Application Specific Integrated Circuits) that embody the above-described structural elements of the display device. When general-purpose computer architectures such as CPU, code ROM, and RAM are adopted for the hardware integrated circuits, a program, in which processing procedures of the above-described structural elements are written in a computer code, may be embedded in the code ROM in advance, and the CPU in the hardware integrated circuits may be caused to execute the processing procedures of the program. The following describes processing procedures that are required in software implementation when general-purpose computer architectures are adopted.

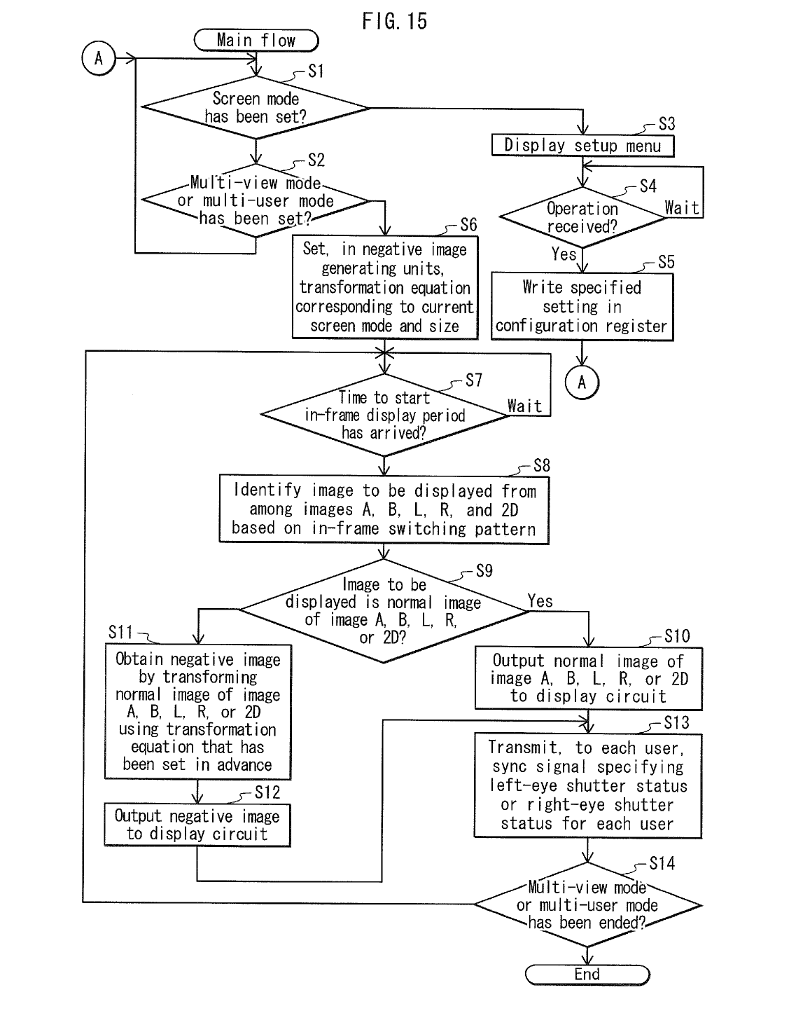

FIG. 15 is a main flowchart showing the processing procedure of the display device. The steps S1 and S2 form a loop. In step S1, it is judged whether or not a screen mode has been set. In step S2, it is judged whether or not the multi-view mode or multi-user mode has been set. When it is judged that a screen mode has been set, the setup menu is displayed in step S3, and an operation is received in step S4. Subsequently, the setting specified by the operation is written in a configuration register in step S5, and the control returns to the loop composed of steps S1 and S2. When it is judged Yes in step S2, equation codes or correction parameters specifying a transformation equation corresponding to the current screen mode and size are set in the negative image generating units in step S6 and the control proceeds to step S7. In step S7, it is judged whether or not the time to start an in-frame display period has arrived. When it is judged that the time to start an in-frame display period has arrived, in step S8, an image to be displayed is identified from among images A, B, L, R, and 2D based on the in-frame switching pattern, and in step S9, it is judged whether or not the image to be displayed is a normal image of image A, B, L, R, or 2D. When it is judged that the image to be displayed is a normal image of image A, B, L, R, or 2D, the normal image of image A, B, L, R, or 2D is output to the display circuit in step S10, and then in step S13, a sync signal specifying the left-eye shutter status or the right-eye shutter status for each user it transmitted to each user. Subsequently, in step S14, it is judged whether or not the multi-view mode or the multi-user mode has been ended, and when it is judged that the multi-view mode or the multi-user mode has not been ended, the control returns to step S7. When it is judged in step S9 that the image to be displayed is not a normal image of image A, B, L, R, or 2D, the control proceeds to step S11 in which a negative image is obtained by transforming the normal image of image A, B, L, R, or 2D using a transformation equation that has been set in advance. Subsequently, in step S12, the obtained negative image is output to the display circuit. After this, in step S13, a sync signal specifying the left-eye shutter status or the right-eye shutter status for each user it transmitted to each user. Subsequently, in step S14, it is judged whether or not the multi-view mode or the multi-user mode has been ended, and when it is judged that the multi-view mode or the multi-user mode has not been ended, the control returns to step S7.

As described above, in the present embodiment, when the image data of two or more view-points constituting a stereoscopic image are a combination of the left-eye image and right-eye image, the normal image of the left-eye image, the negative image of the left-eye image, the normal image of the right-eye image, and the negative image of the right-eye image are displayed in one frame by time sharing. This makes it possible for the normal images for the left eye and right eye to be negated by the negative images for the left eye and right eye, respectively, when the stereoscopic image is viewed without wearing the shutter-type glasses. With this structure, the user recognizes the displayed image as an image having a uniform brightness over the entire screen. Thus when the generating device is displayed in the shop as a multi-view-supporting display device, it does not give an unpleasant feeling to the user.

Also, a control may be performed so that the shutters of the shutter-type glasses are closed while the negative images for the left eye and the right eye are displayed. With this control, the user wearing the shutter-type glasses can view the normal images, and the user not wearing the shutter-type glasses cannot view an image. In this way, it is possible to allow only predetermined users (those who are wearing the shutter-type glasses) to view the stereoscopic image.

When a plurality of normal image display periods and a plurality of negative image display periods are assigned in one frame, it is possible to control the brightness of the screen by setting the number of display periods in which the shutter is opened, among the plurality of negative image display periods.

[Advantageous Effects of Invention]

The invention of a generating device described in the present embodiment is a generating device for generating images to be viewed by a user wearing glasses, comprising: an obtaining unit configured to obtain a normal image; and a generating unit configured to generate a negative image that negates the obtained normal image, wherein the glasses, when worn by the user, allow the user to view one or more of a plurality of images displayed by a time sharing in a frame period of an image signal, the normal image and the negative image are displayed by the time sharing, and for each pair of a pixel included in the negative image and a pixel included in the normal image that correspond to each other, a luminance of a pixel in the negative image is set to a value greater than a difference obtained by subtracting a luminance of a corresponding pixel in the normal image from a maximum value in a range of luminance values that can be taken by each pixel.

According to the invention, when a normal image to be displayed by a display device supporting the multi-view mode is composed of a pair of a left-eye image and a right-eye image, the following images are displayed by time sharing in one frame period: a normal image for the left eye; a negative image for the left eye; a normal image for the right eye; and a negative image for the right eye. When viewed by a user not wearing the glasses, the normal images for the left eye and right eye are negated by the negative images for the left eye and right eye, respectively. With this structure, the user recognizes the displayed image as an image having a uniform brightness over the entire screen. Thus when the multi-view-supporting display device is displayed in the shop, it does not give an unpleasant feeling to the user. Accordingly, the present invention supports the manufacturers to bring a new product into the market, succeed in establishing a brand image thereof, and take a market share. The invention of the above generating device thus contributes to the domestic industries in various ways.

Also, by performing a control to close the shutters of the glasses worn by the user during the display periods in which the negative images for the left eye and right eye are displayed, it is possible to allow a user wearing the glasses to view the normal image, and prevent a user not wearing the glasses from viewing the normal image. Thus it is possible to allow only specific users who wear the glasses to view a stereoscopic image.

When a user sees an image in the multi-view mode or the multi-user mode on such a device, the user does not have an unpleasant feeling. Furthermore, it is possible to display a message, which urges a user not wearing glasses to wear the glasses, on the screen having a uniform brightness due to display of the negative image.

In the above-described generating device, the glasses may be shutter-type glasses, and the generating device may be a display device and further comprise: a displaying unit configured to display the normal image and the negative image in one frame period by the time sharing; and a transmitting unit configured to transmit a sync signal defining whether a left-eye shutter of the glasses is in an opened status or a closed status and whether a right-eye shutter the glasses is in the opened status or the closed status, when a display of the normal image or the negative image is started.

A plurality of display periods can be assigned to each of the normal image and the negative image in one frame period. In that case, it is possible to control the brightness of the screen by adjusting the number of display periods during which the shutters are opened or closed.

In the above-described generating device, the normal image may include a first normal image and a second normal image, the first normal image being an image for users who wear the glasses, the second normal image being an image for users who do not wear the glasses, and the first normal image and the negative image appear with equal frequency in one frame period, and the sync signal transmitted by the transmitting unit defines that the negative image is displayed while the left-eye shutter and the right-eye shutter are both in the closed status. This structure provides a viewing method in which a person can view a 2D image when not wearing glasses, and can view a 3D image by wearing the glasses.

### Embodiment 2

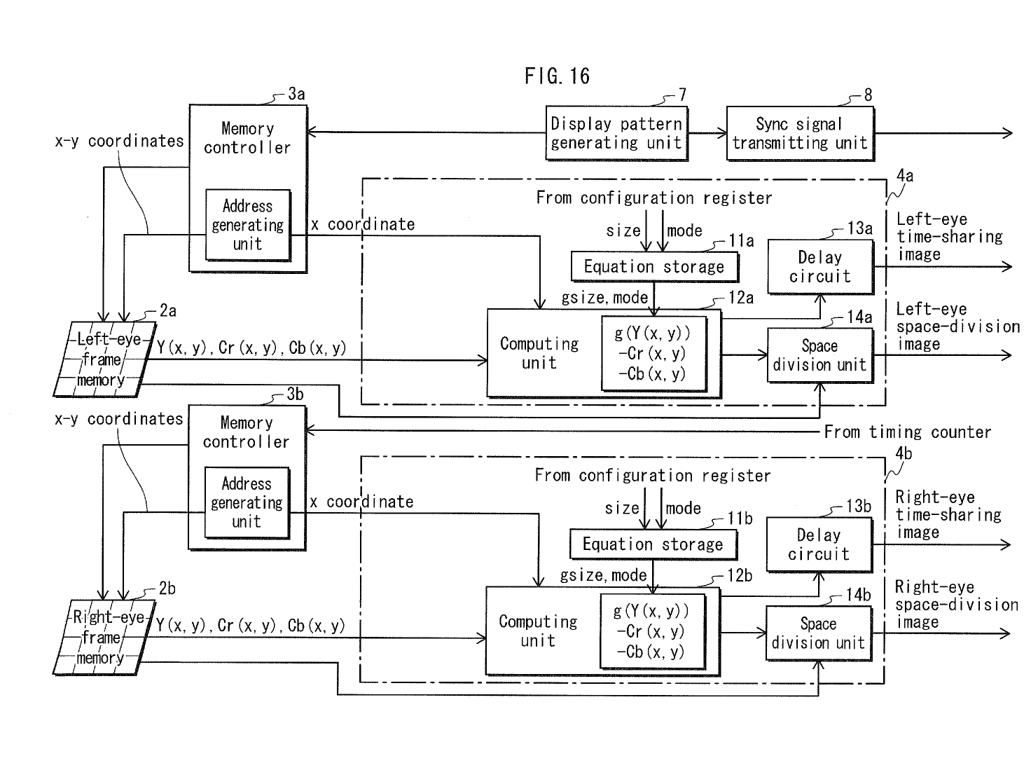

In Embodiment 1, the normal image and the negative image are switched over the entire screen by time sharing. In the present embodiment, the normal image and the negative image are switched in a part of the screen. To realize this structure, the negative image generating units described in Embodiment 1 are improved. FIG. 16 illustrates the internal structure of the negative image generating units 4a and 4b in Embodiment 2. FIG. 16 is drawn based on FIG. 10. The structure illustrated in FIG. 16 differs from the structure illustrated in FIG. 10 in that is additionally includes space division display units 14a and 14b. The added constitutional elements are described in the following.

<Space Division Display Units 14a and 14b>

The space division display units 14a and 14b realize a space division display in a partial region of the display screen by switching between the normal image and the negative image for each checkerboard and for each line. Note that the line here means a rectangular region composed of pixels constituting a horizontal row of the screen, and the checkerboard means a small region that is obtained by dividing the screen into small rectangular regions. It is possible to overlay the normal image with the negative image by displaying the normal image and the negative image for each checkerboard and for each line. When the screen of the display device is seen without wearing the shutter-type glasses, the brightness of the screen is uniform, and nothing can be seen. On the other hand, the user wearing the shutter-type glasses can view the normal image when the shutter status of the shutter-type glasses is controlled so that only the normal image is transmitted through the shutter, among the normal image and the negative image that are disposed for each checkerboard and for each line.

With the addition of the new structural elements, existing structural elements (negative image generating units 4a and 4b) need to be improved uniquely to the present embodiment. The following describes the structural elements that are improved uniquely to the present embodiment.

The negative image generating units 4a and 4b realize a time sharing display by transforming a part of the pixels constituting the normal image, by using a transformation equation. The normal image and a negative image, whose partial pixels have been replaced with negative pixels, are displayed by time sharing. The display of the normal image and the negative image, whose pixels have partially been replaced with negative pixels, realizes a partial negation of the normal image. This completes the explanation of the addition and improvement of the structural elements unique to Embodiment 2.

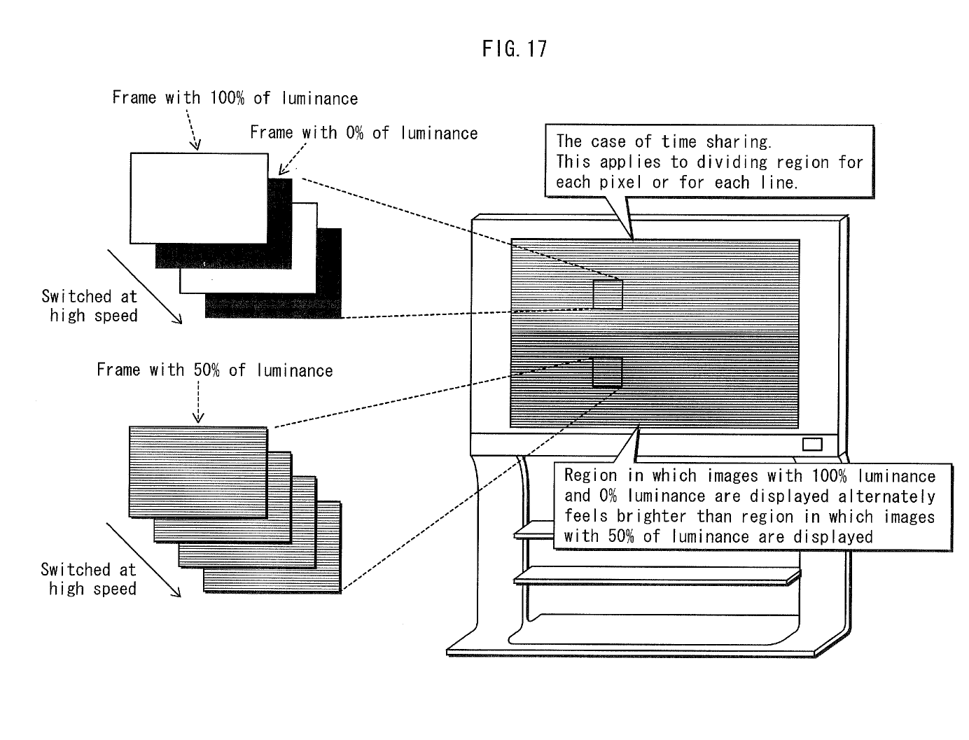

The following describes the technical meaning of the partial negation of the normal image. The partial negation of the normal image requires avoiding imbalance in brightness between the target and non-target regions of the time-sharing display and the space-division display. FIG. 17 illustrates a visual effect produced by a partial negation. In the upper half of the screen, 100% pixels and 0% pixels are displayed by time sharing, and in the lower half of the screen, 50% pixels and 50% pixels are displayed by time sharing. In this case, the user feels the upper half is brighter than the lower half. This is attributable to the visual property and the correction made by the display device. It is possible to realize a viewable display by alternately displaying 100% pixels and 0% pixels. This applies to the space division as well.

When the normal image is data whose luminance value is the maximum luminance value, and the negative image is data whose luminance value is 0, the overlaid image, which is obtained by displaying the normal image and the negative image by time sharing, appears brighter than an overlaid image which is obtained by displaying a plurality of images each having 50% luminance. This is attributable to (i) the visual property of human being that, when a bright point and a dark point are alternately displayed, the bright point is visible well, and (ii) the correction function of the display device that corrects the luminance of two images that are switched at a high speed, to a brighter luminance, not to an average value of the luminance values of the two images. This drawing indicates that in the dark place, the eyes of human being do not recognize the change of brightness as much as the change of the luminance value, while in the bright place, the eyes recognize the change of brightness as greater than the change of the luminance value.

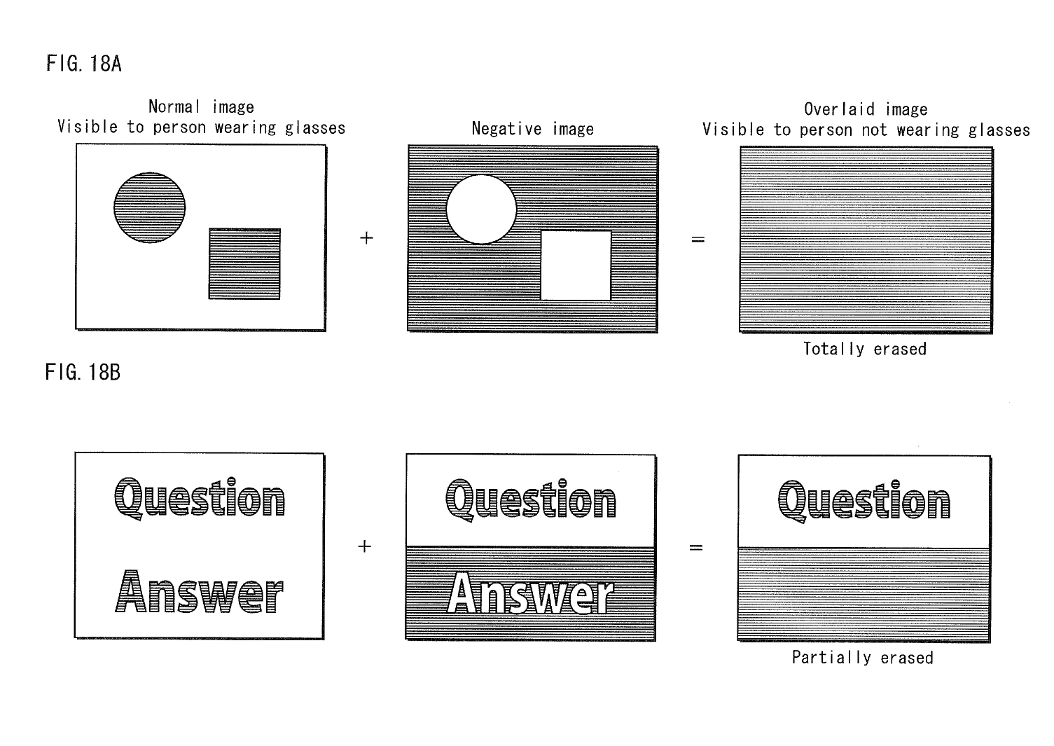

FIGS. 18A and 18B illustrate, in the form of equation “A+B=C”, a normal image, a negative image, and an overlaid image that is obtained by the time-sharing/space-division display. In FIGS. 18A and 18B, A in the equation is the normal image, B is the negative image, and C is the overlaid image obtained by the time-sharing display. When the normal image and the negative image are displayed alternately by time sharing, the brain of human beings overlays the normal image with the negative image using the afterimages in the eyes, and obtains an overlaid image in which the images have been totally erased. FIG. 18A illustrates a case where partial regions of the screen are switched at a high speed to realize a partial erasure. FIG. 18B illustrates, in the form of the equation, a case where the normal image is overlaid with the negative image by switching the lower portion of the screen at a high speed. As indicated by the right member of the equation, a partial erasure is realized in the lower portion of the screen. As illustrated in FIG. 18B, it is possible to render a part of the screen unrecognizable by erasing the image only in the lower portion of the screen.

As described, in the present embodiment, a part of the normal image is switched, and for example, a video content providing a quiz, the answer of the quiz can be seen only when the shutter-type glasses are worn, otherwise the answer cannot be seen. This broadens the creation base for the interactive control using a content.

### Embodiment 3

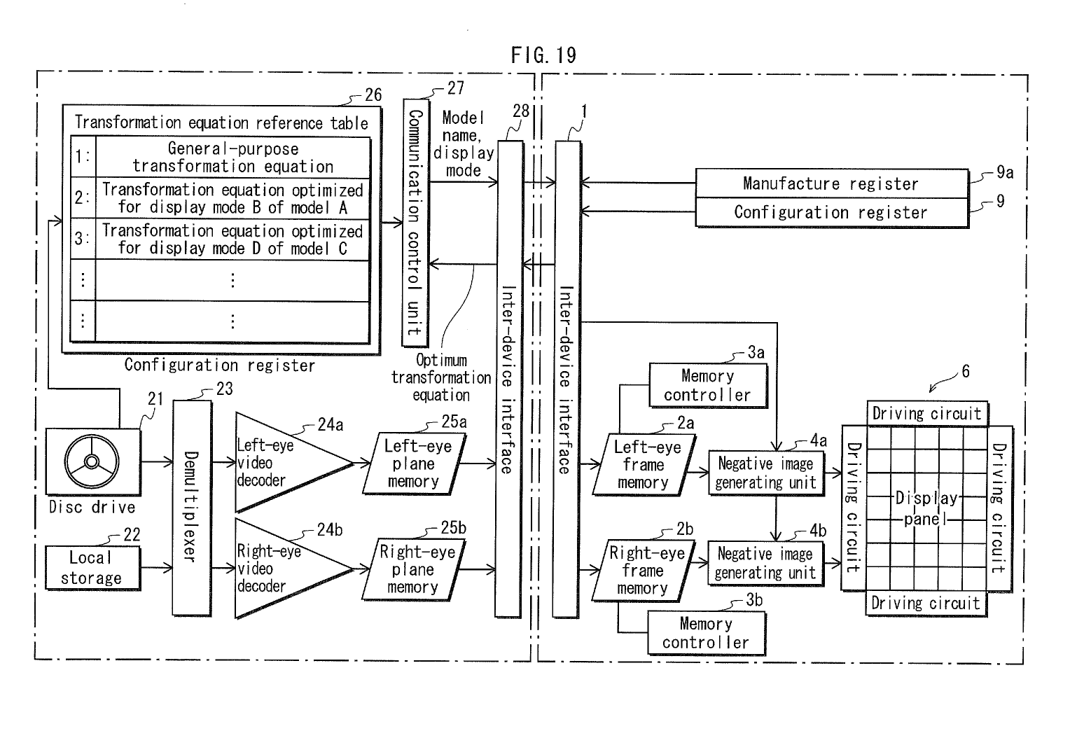

In Embodiment 1, the display device 200 selects a transformation equation used to generate a negative image. In the present embodiment, it is the playback device that selects a transformation equation used to generate a negative image. More specifically, when the playback device connected with the display device holds equation codes or correction parameters specifying transformation equations, the playback device obtains identification information, such as model information (model number information), of the connected display device and the currently selected screen mode from the display device, and generates a negative image in accordance with an equation code or a correction parameter that specifies a transformation equation corresponding to the combination of the display device and the screen mode. FIG. 19 illustrates the internal structure of the playback device having the improvement unique to the present embodiment. FIG. 19 illustrates the internal structure of the playback device in Embodiment 3. The present device is supposed to process the left-eye and right-eye images, and thus its internal structure includes pairs of structural elements that have the same structure and are used differently: one used for the left-eye; and the other used for the right-eye. Such structural elements that have the same structure and are used for the left-eye and the right-eye are distinguished from the other structural elements in that they are assigned, as the reference signs, the same number and alphabets “a” and “b”. In the following, with regard to the structural elements that have the same structure and are used for the left-eye and the right-eye, merely a process common to them is explained since the structures are the same.

As illustrated in FIG. 19, the playback device includes a disc drive 21, a local storage 22, a demultiplexer 23, a left-eye video decoder 24a, a right-eye video decoder 24b, a left-eye plane memory 25a, a right-eye plane memory 25b, a configuration register 26, a communication control unit 27, and an inter-device interface 28.

The disc drive 21 holds a disc medium on which a content for stereoscopic viewing has been recorded, and executes reading/writing from or to the recording medium. The recording medium has various types such as a read-only medium, a rewritable and removable medium, and a rewritable built-in medium. The playback device is also equipped with a random access unit. The random access unit executes a random access from an arbitrary time point on a time axis of the video stream. Note that the video stream is classified into a normal video stream and a multi-view video stream. The multi-view video stream is a video stream for stereoscopic viewing and is composed of a base-view video stream and a dependent-view video stream. More specifically, when instructed to play back a video stream from an arbitrary time point on a time axis of the video stream, the random access unit searches for a source packet number of an access unit that corresponds to the arbitrary time point, by using an entry map that is a type of scenario data. The access unit includes picture data that can be decoded independently, or includes a pair of view components. The view components are structural elements constituting a stereoscopic image. Each of a right-eye image and a left-eye image is a view component. The above-mentioned searching is performed to identify a source packet number of a source packet that stores an access unit delimiter for the access unit. Reading from the source packet identified by the source packet number and decoding are executed. When a scene jump is performed, a random access is executed by executing the above-described searching by using time information indicating a branch destination. A transportation transformation equation reference table, in which equation codes or correction parameters specifying transformation equations are written, is read from an optical disc such as Blu-ray, and is used in the process of generating a negative image.

The local storage 22 stores the transportation transformation equation reference table in which equation codes or correction parameters specifying transformation equations are written. The contents of the local storage 22 are always updated to the latest information.

The demultiplexer 23 demultiplexes an input stream, and outputs a plurality of types of packetized elementary streams. The elementary streams output in this way includes a video stream, a subtitle graphics stream, an interactive graphics stream, and an audio stream. Among these streams, the video stream is output to the left-eye video decoder 24a and the right-eye video decoder 24b. The subtitle graphics stream and the interactive graphics stream are sent to graphics decoders (not illustrated) that are respectively dedicated to these graphics streams. The audio stream is sent to an audio decoder (not illustrated).

The left-eye video decoder 24a decodes the left-eye image data that is a view component constituting the base-view video stream.

The right-eye video decoder 24b decodes the right-eye image data that is a view component constituting the dependent-view video stream. Each of the left-eye video decoder 24a and the right-eye video decoder 24b includes a coded data buffer and a decode data buffer, preloads the view component constituting the dependent-view video stream into the coded data buffer, and decodes a view component of a picture type (IDR type) that is intended to set a decoder refresh at the start of a close GOP in the base-view video stream. When this decoding is performed, the coded data buffer and the decode data buffer are all cleared. After decoding the view component of the IDR type, the left-eye video decoder 24a and the right-eye video decoder 24b decode: a view component that follows a base-view video stream that has been compress-encoded based on the correlativity with the above view component; and a view component of a dependent-view video stream. When non-compressed picture data for the view component is obtained by the decoding, the picture data is stored in the decode data buffer, and is set as a reference picture.

Using the reference picture, the left-eye video decoder 24a and the right-eye video decoder 24b perform motion compensations for the view component following the base-view video stream and for the view component of the dependent-view video stream. The motion compensations allow for non-compressed picture data to be obtained for the view component following the base-view video stream and for the view component of the dependent-view video stream. The obtained non-compressed picture data are stored in the decode data buffer and used as reference pictures. The decoding is performed when a decode start time specified by a decode time stamp of each access unit arrives.

The left-eye plane memory 25a stores non-compressed left-eye picture data that is obtained by the decoding performed by the left-eye video decoder 24a.

The right-eye plane memory 25b stores non-compressed right-eye picture data that is obtained by the decoding performed by the right-eye video decoder 24b.

The configuration register 26 stores the transformation equation reference table when it is read from the disc medium. The transformation equation reference table indicates correspondence between a plurality of transformation equations and a plurality of combinations of a model name and a screen mode. In Embodiment 1, transformation equations are associated with combinations of a screen size and a screen mode. In the present embodiment, the transformation equation reference table associates the transformation equations with combinations of a model name of the display device and a screen mode. This means that the transformation equation reference table of the present embodiment is defined by the producer of the movie, and that, since the producer of the movie does not grasp details of the properties of the display device as the manufacturer of the display device does, the producer simplifies the correspondence on the presumption that one model of the display device has one screen size. In the example illustrated in FIG. 19, a transformation equation is associated with a combination of model A and display mode B, and a transformation equation is associated with a combination of model C and display mode D.

The communication control unit 27 selects, from among a plurality of transformation equations written in the transformation equation reference table, a transformation equation that matches the combination of: a model name of, and obtained from, the display device connected with the playback device; and the currently selected screen mode, and sets the selected transformation equation in the display device via the inter-device interface 28.

The inter-device interface 28 transfers decoded video or audio via, for example, a composite cable, a component cable or a multimedia cable conforming to the HDMI standard. In particular, the HDMI allows for addition of various types of property information to the video. When the multimedia cable interface of the inter-device interface 28 is used instead of the network interface, the performance information of the device that executes the display process via the multimedia cable interface is stored.

A left-eye image is obtained by decoding a base-view video stream and a right-eye image is obtained by decoding a dependent-view video stream as described above, a negative image is generated based on the obtained left-eye and right-eye images, and a time-sharing display of normal image—negative image is realized.

The playback device of the present embodiment can be manufactured industrially by using hardware elements that embody the above-described structural elements of the playback device. However, implementation of the playback device by software is also possible. That is to say, the present playback device can be manufactured industrially by embedding into a code ROM a program in which the processing procedures of the above-described structural elements are written in a computer code, and causing a single processing unit (CPU) in the hardware structure of the device to execute the processing procedure of this program. The following describes a processing procedure required for the software implementation of the device, with reference to a flowchart.

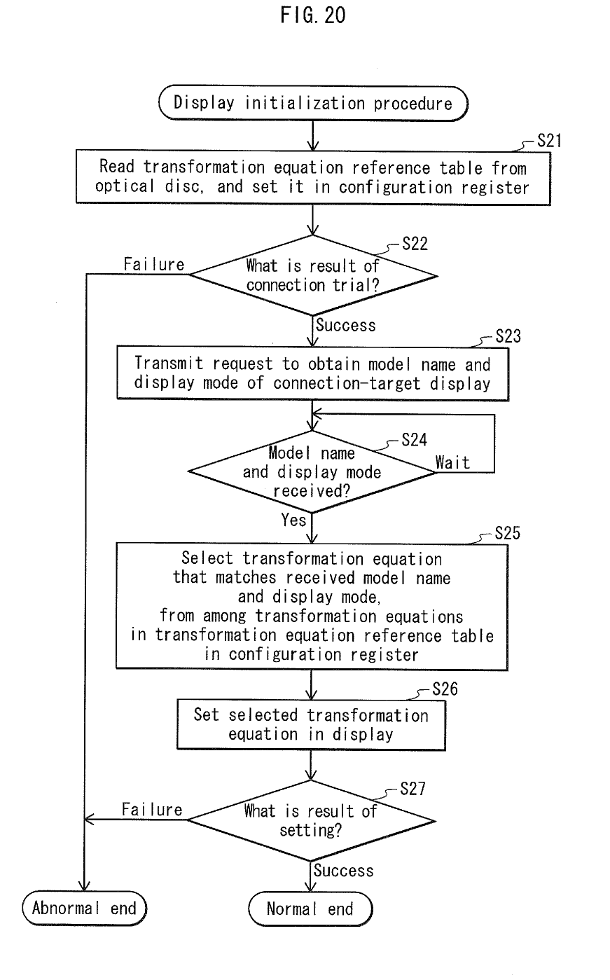

FIG. 20 is a flowchart showing the procedure for initializing the display device. In step S21, the transformation equation reference table is read, and in step S22, a connection with the display device is tried. When the connection is established, in step S23, a request to obtain the display mode and the model name of the connected display device is transmitted. Subsequently, in step S24, the model name and display mode are waited to be received. After they are received, in step S25, a transformation equation, which matches the received model name and display mode, is selected from among transformation equations in the transformation equation reference table stored in the configuration register. The selected transformation equation is transmitted to the display device, and the display device sets the transformation equation (step S26). It is judged whether the setting has resulted in the success or failure (step S27). When it is judged that the setting has resulted in the success, the negative image generating unit of the display device is caused to generate a negative image by using the transformation equation.

As described above, according to the present embodiment, the playback device, which reads image data from an optical disc, generates the negative image. This structure enables a negative image to be generated along the intention of the author because the playback device operates in accordance with the application loaded from the optical disc. This further increases the quality of the negative image.

Also, in this structure, a table is read from the optical disc, and from among a plurality of transformation equations written in the table, a transformation equation that is optimum for the display device is selected. This makes it possible for the content creator to create a negative image reflecting an intention of the content creator. With this structure, the producer, who totally knows the patterns and colors of the content, can cause the transformation equations reflect his/her intention, and thus can make the negation by the negative image appear more cleanly.

[Advantageous Effects of Invention]

The invention of a playback device described in the present embodiment (hereinafter referred to as “present invention”) is obtained by adding the following limitations to the invention of generating device described in Embodiment 1. That is to say, the generating device being a playback device further comprising: a reading unit configured to read a transformation equation reference table from a recording medium, the transformation equation reference table showing correspondence between a plurality of transformation equations and a plurality of combinations of a screen size and a screen mode, and the generating unit extracts, from the transformation equation reference table, a transformation equation corresponding to a combination of a screen size and a screen mode of a connected display device, and generates a negative image by using the extracted transformation equation.

With the above structure, when the display device provides various display modes such as a high-contrast mode and a movie mode, it is possible to select an optimum transformation equation in accordance with the property of the selected mode. This makes it possible to avoid occurrence of an inconvenience that the left-eye and right-eye images are viewed as overlapping images after the display mode is changed. With the above structure, the playback device reads the table from the recording medium, and generates a negative image by using a transformation equation written in the table. It is thus possible to obtain the luminance of a negative image by transforming the luminance of a normal image using a transformation equation along the intention of the author. Also, in this structure, a table is read from the optical disc, and from among a plurality of transformation equations written in the table, a transformation equation that is optimum for the display device is selected. This makes it possible for the content creator to create a negative image reflecting an intention of the content creator. With this structure, the producer, who totally knows the patterns and colors of the content, can cause the transformation equations reflect his/her intention, and thus can make the negation by the negative image appear more cleanly.

### Embodiment 4

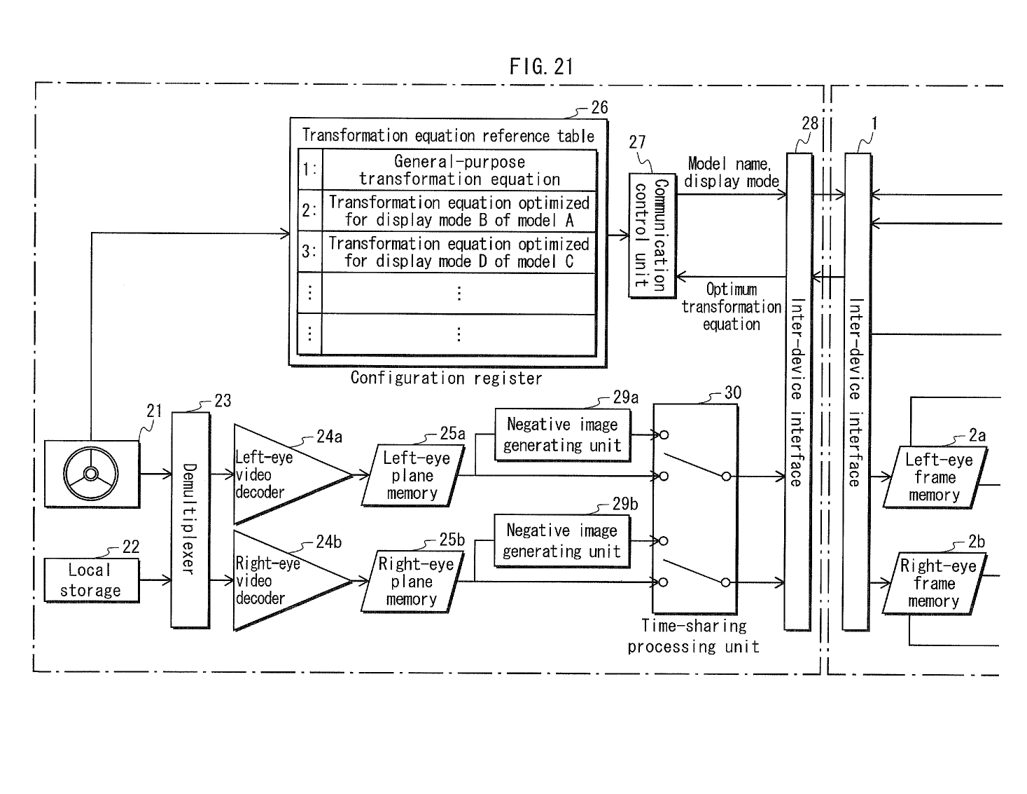

In Embodiment 3, the playback device selects a transformation equation and realizes a time-sharing process. The present embodiment relates to an improvement in which the playback device side realizes a time-sharing process. FIG. 21 illustrates the internal structure of the playback device in Embodiment 4. FIG. 21 is drawn based on FIG. 19. The structure illustrated in FIG. 21 differs from the structure illustrated in FIG. 19 in that it additionally includes the following structural elements.

That is to say, negative image generating units 29a and 29b and a time-sharing processing unit 30 have been added, wherein the negative image generating units 29a and 29b generate negative images that negate images stored in the plane memories, and the time-sharing processing unit 30 outputs, to the display device, normal images stored in the plane memories and negative images generated by the negative image generating units so that a time-sharing display can be realized.

As described above, according to the present embodiment, the playback device reads a reference table from the recording medium, and generates a negative image based on the transformation equations written in the transformation equation reference table. This structure makes it possible to obtain a luminance of the negative image by transforming the luminance of the normal image by using a transformation equation along with an intention of the author.

### Embodiment 5

In Embodiment 1, a time-sharing display is realized only with regard to video. The present embodiment relates to an improvement for realizing a space-division display of a video with a subtitle. In the present embodiment, an image overlaid with a subtitle and an image overlaid with a negative subtitle are included in the images displayed in one frame period in the time-sharing display.

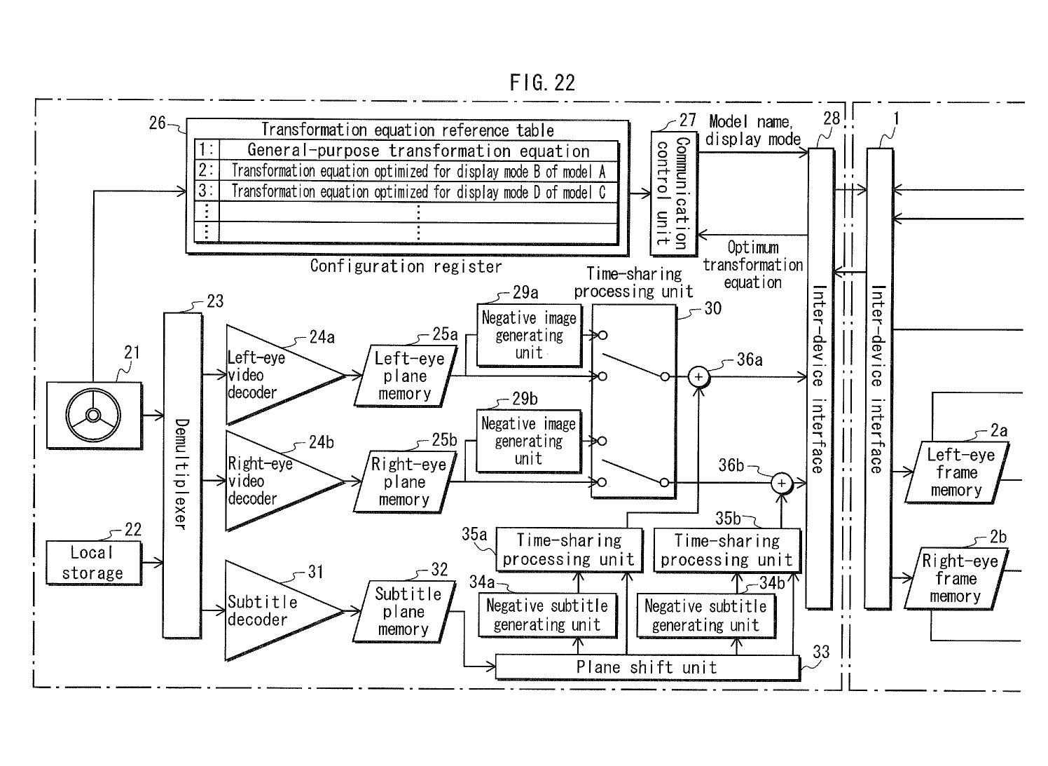

FIG. 22 illustrates the internal structure of the playback device having the improvement unique to the present embodiment. FIG. 22 illustrates the internal structure of the playback device in Embodiment 5. FIG. 22 is drawn based on the internal structure drawing of Embodiment 4, and differs from the structure in Embodiment 4 in that structural elements belonging to the subtitle system are added.

The added structural elements belonging to the subtitle system are: a subtitle decoder 31 for decoding a subtitle; a subtitle plane memory 32 for storing a bit map obtained by decoding a subtitle; a plane shift unit 33 for obtaining a left-eye subtitle and a right-eye subtitle by performing a plane shift onto the bit map stored in the subtitle plane memory; negative subtitle generating units 34a and 34b for obtaining a left-eye negative subtitle and a right-eye negative subtitle that negate the left-eye subtitle and the right-eye subtitle obtained by the plane shift, respectively; time-sharing processing units 35a and 35b for outputting by the time sharing the left-eye subtitle and the right-eye subtitle, or the left-eye negative subtitle and the right-eye negative subtitle; and overlaying units 36a and 36b for overlaying the output left-eye subtitle or the output left-eye negative subtitle with the left-eye image, and overlaying the output right-eye subtitle or the output right-eye negative subtitle with the right-eye image. Among these structural elements, the negative subtitle generating units 34a and 34b for generating the negative subtitles have the same structures as the negative subtitle generating units 4a and 4b of Embodiment 1. The reason why the negative subtitles are generated based on the same principle as the negative subtitle generating units 4a and 4b of Embodiment 1 is that the luminance of a subtitle has the same visual properties as the luminance of an image described in Embodiment 1. The following describes the subtitle decoder in detail.

The subtitle decoder includes a graphics decoder and a text subtitle decoder. The graphics decoder includes: a coded data buffer for storing functional segments read from a graphics stream; a stream processor for obtaining an object by decoding screen composition segments that define the graphics screen composition; an object buffer for storing the object obtained by the decoding; a composition buffer for storing the screen composition segments; and a composition controller for decoding the screen composition segments stored in the composition buffer, and based on the control items defined by the screen composition segments, performing a screen composition on the plane by using the object stored in the object buffer.

The text subtitle decoder includes: a subtitle processor for separating text code and control information from subtitle description data contained in a text subtitle stream; a management information buffer for storing the text code separated from the subtitle description data; a control information buffer for storing the control information; a text render for expanding the text code stored in the management information buffer into a bit map by using font data; an object buffer for storing the bit map obtained by the expanding; and a rendering control unit for performing a control on the playback of the text subtitle along a time axis by using the control information separated from the subtitle description data.

The first part of the text subtitle decoder includes: a font preload buffer for preloading font data; a transport stream (TS) buffer for adjusting the input speed of TS packets that constitute the text subtitle stream; and a subtitle preload buffer for preloading the text subtitle stream before a playback of a play item. This completes the description of the subtitle decoder. The following describes details of the display device in the present embodiment.

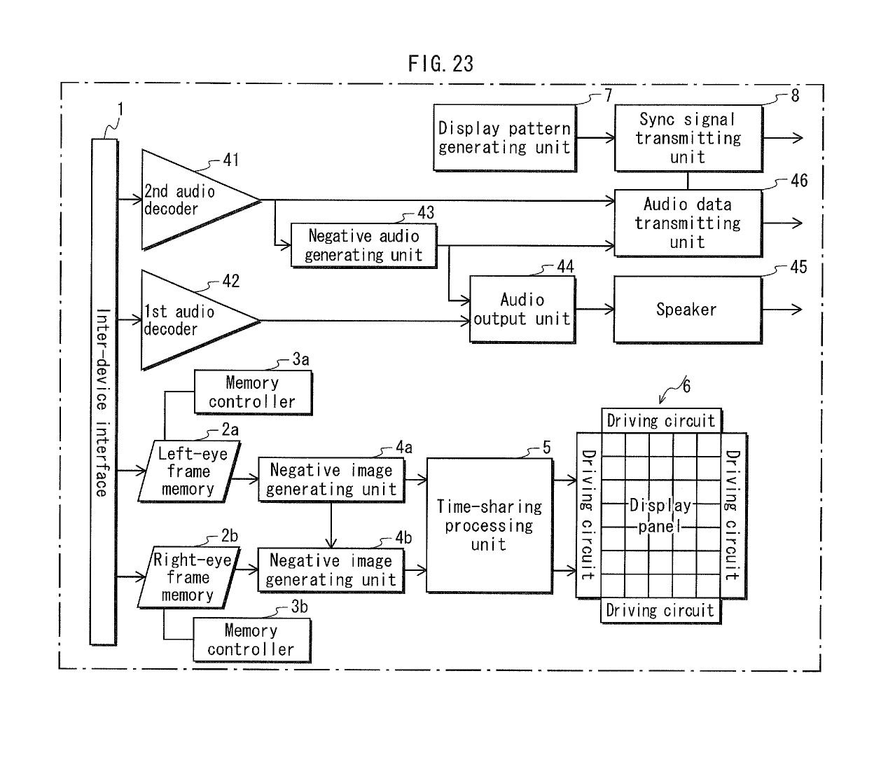

FIG. 23 illustrates the internal structure of the display device in Embodiment 5. FIG. 23 is drawn based on the internal structure drawing of Embodiment 1, and differs from the structure in Embodiment 1 in that it additionally has an audio processing system.

The added audio processing system includes a 1st audio decoder 41 for decoding a first audio stream; a 2nd audio decoder 42 for decoding a second audio stream; a phase inverter 43 for inverting the phase of non-compressed audio data output from the 2nd audio decoder 42; an audio output unit 44 for outputting audio from the 1st audio decoder and the 2nd audio decoder to a speaker 45 so that the audio is output from the speaker 45; the speaker 45; and an audio data transmitting unit 46 for transmitting phase-inverted non-compressed audio data to the shutter-type glasses. The audio data transmitting unit 46 transmits negative audio data, which negates audio output from the display device, to the shutter-type glasses, and causes the shutter-type glasses to output the transmitted negative audio data.

This completes the description of the display device. The following describes relationships with an existing structural element (sync signal transmitting unit 13), as a supplement to the description of new structural elements.

The sync signal transmitting unit 13 transmits a special sync signal. The special sync signal controls the shutter-type glasses to close shutters during a period in which an image overlaid with the negative subtitle is displayed. This completes the description of the display device. The following describes details of the shutter-type glasses.

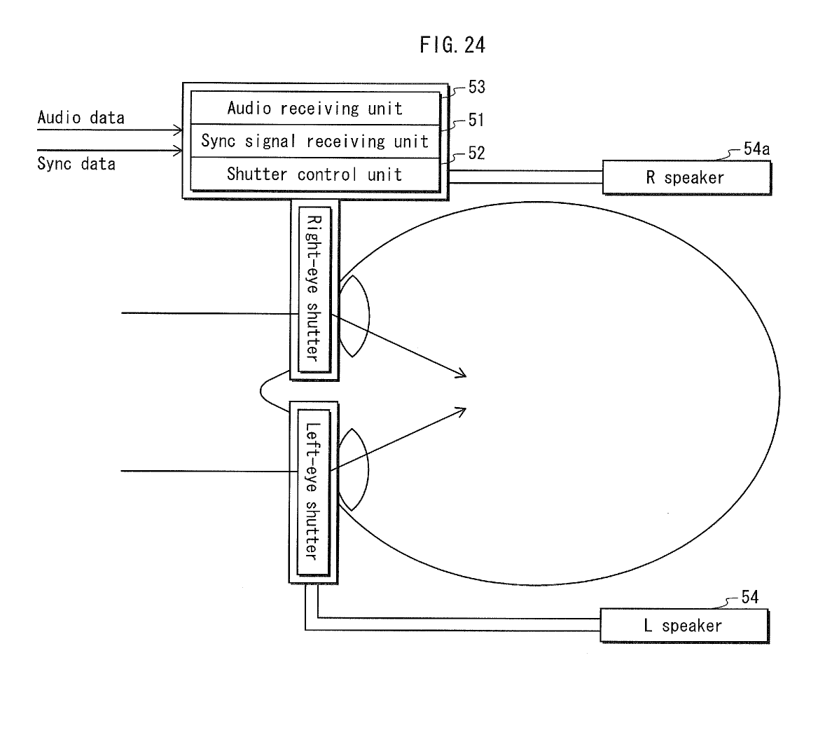

FIG. 24 illustrates the internal structure of the shutter-type glasses. As illustrated in FIG. 24, the shutter-type glasses include a sync signal receiving unit 51 for receiving a sync signal transmitted from the display device; a shutter control unit 52 for controlling opening/closing of the left-eye shutter and right-eye shutter; an audio receiving unit 53 for receiving audio data transmitted from the display device; and speakers 54a and 54b for outputting received audio.

This completes the description of the shutter-type glasses in the present embodiment. The following describes how the images are provided by the above-described internal structure to the user.

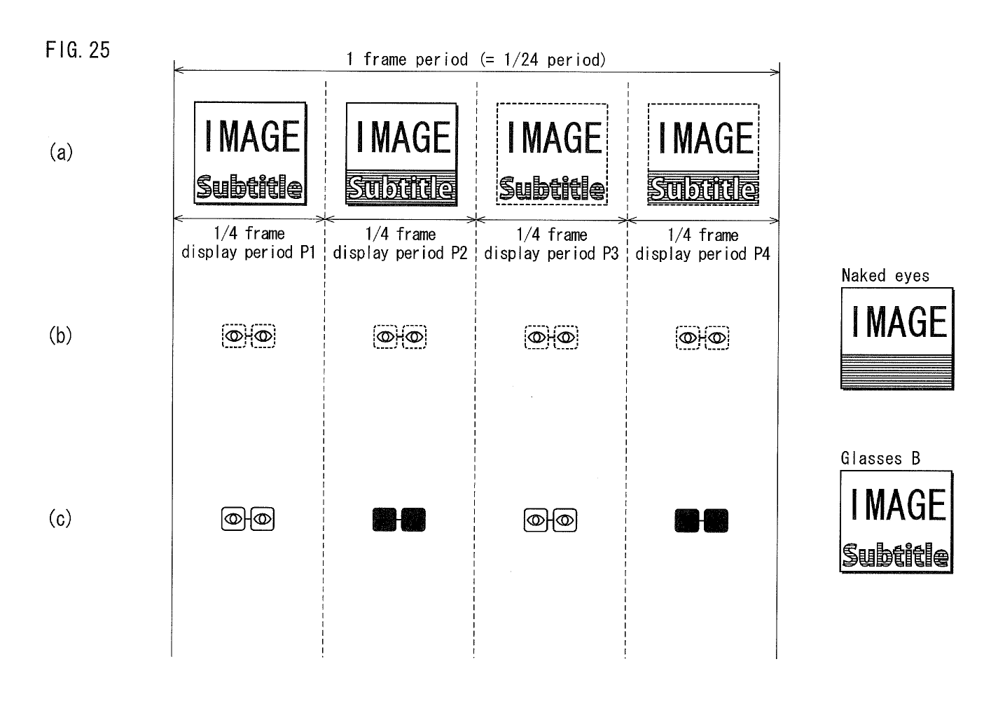

FIG. 25 illustrates a time-sharing display of an image with a subtitle and an image without a subtitle. The portion (a) indicates that an image with English subtitle, an image with a negative subtitle, an image with English subtitle, and an image with a negative subtitle are displayed in respective four ¼ frames obtained by division of one frame, by time sharing. The portion (b) indicates viewing without wearing the shutter-type glasses. When the image with English subtitle and the image with a negative subtitle are displayed substantially at the same time in this way, a total erasure of the subtitle is realized. The portion (c) indicates sync signals transmitted by the sync signal transmitting unit. The example provided in FIG. 25 indicates that the sync signal instructs the shutters to be opened during the display periods of the first ¼ frame and the third ¼ frame, and closed during the remaining display periods. Since, in this example, the periods during which the shutters are closed are periods in which the English subtitle is overlaid with the image, a user wearing the glasses B views the image with English subtitle.

When an image with a subtitle and an image with a negative subtitle are displayed alternately at a high speed as illustrated in FIG. 25, a user not wearing the shutter-type glasses can see the image portion, but cannot recognize the subtitle since the subtitle is negated by the negative image. On the other hand, a user wearing the shutter-type glasses can view the image with the subtitle correctly since the shutters are opened at the timings when the image with the subtitle is displayed.

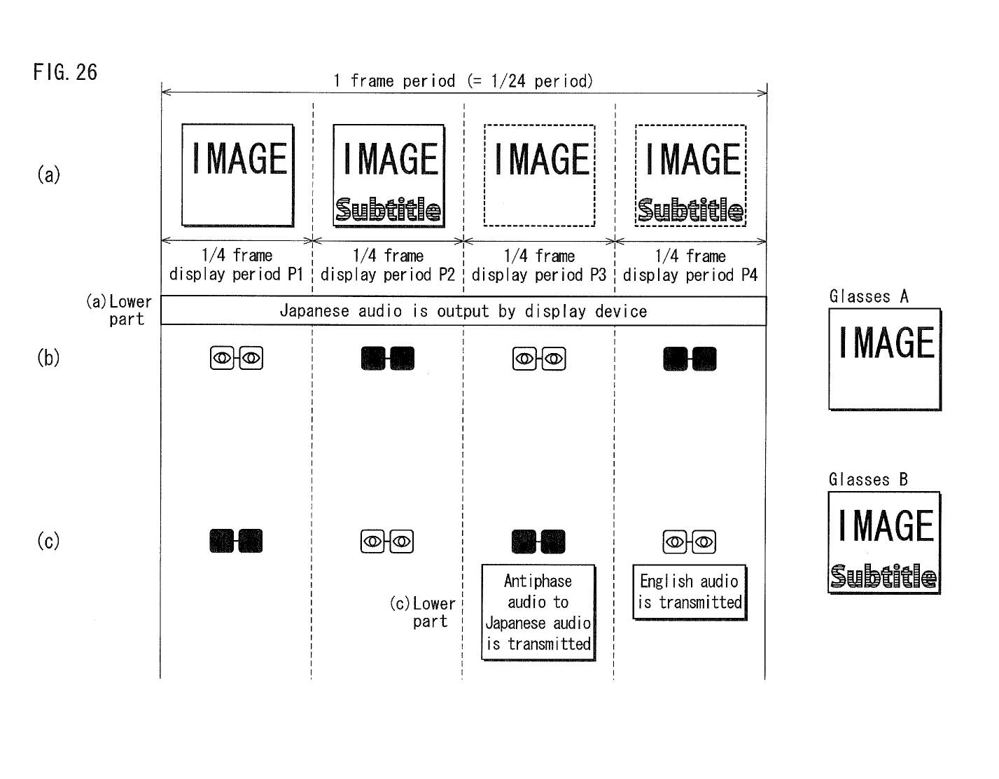

FIG. 26 illustrates a time-sharing display of an image with a subtitle and an audio in a specific language. The portion (a) of FIG. 26 indicates that an image without subtitle, an image with English subtitle, an image without subtitle, and an image with English subtitle are displayed in respective four ¼ frames obtained by division of one frame, by time sharing. The lower part of (a) indicates an audio output from the display device. As indicated by the lower part of (a), in this example, the display device is outputting only Japanese audio. The portion (b) of FIG. 26 indicates sync signals received by the shutter-type glasses. The example provided in FIG. 26 indicates that the sync signal instructs the shutters to be opened during the display periods of the first ¼ frame and the third ¼ frame, and closed during the display periods of the other ¼ frames. Since, in this example, the shutters of shutter-type glasses A are closed during the periods in which the subtitle is displayed, a user wearing the shutter-type glasses A can view only the image, not viewing the subtitle.

The portion (c) of FIG. 26 indicates sync signals transmitted by the sync signal transmitting unit. The example provided in FIG. 26 indicates that the sync signal instructs the shutters to be opened during the display periods of the second ¼ frame and the fourth ¼ frame, and closed during the remaining display periods. This allows a user wearing shutter-type glasses B to view the image with English subtitle. The lower part of (c) indicates audio data to be transmitted to the shutter-type glasses B. In this example, antiphase audio to Japanese audio and English audio are transmitted to the shutter-type glasses B. The antiphase audio negates the audio output from the display device. This is based on the same principle as the noise canceller. With this structure, the Japanese audio from the display device is negated by the antiphase audio, and the user wearing the shutter-type glasses B can hear only the English audio.

As described above, FIG. 26 illustrates an example in which: a person not wearing the shutter-type glasses A can see the image, but not the subtitle, can hear the Japanese audio from the speaker of the television; and a person wearing the shutter-type glasses can see the image with the subtitle and can hear the English audio from the earphone attached to the shutter-type glasses.

The audio that can hear through the earphone attached to the shutter-type glasses contains the English audio and the antiphase audio to the Japanese audio that is output from the speaker. As a result, when the person listens to the audio via the earphone together with the audio output from the speaker of the television, the person can hear the background and effect audio as they are, together with the English audio, but cannot hear the Japanese audio because it is negated by the antiphase audio.

As described above, according to the present embodiment, it is possible to realize a viewing style where a person wearing the shutter-type glasses A can see the image, but not the subtitle, can hear the Japanese audio from the earphone paired with or attached to the shutter-type glasses, and a person wearing the shutter-type glasses B can see the image with the subtitle and can hear the English audio from the earphone attached to the shutter-type glasses B. When viewing the same movie, a child can wear the shutter-type glasses A to view a dubbed version, and an adult can wear the shutter-type glasses B to view the Japanese subtitle and hear the English audio. In this way, it is possible to build a viewing environment in which different shutter-type glasses are used in combination to provide different contents of subtitle and audio to two users, of which one is wearing shutter-type glasses and the other is not. In particular, the system is expected to evolve into language teaching materials.

[Advantageous Effects of Invention]

The invention described in the present embodiment (hereinafter referred to as “present invention”) is obtained by adding the following limitations to the invention of display device described in Embodiment 1.

That is to say, the normal image may include a third normal image and a fourth normal image, the third normal image being a normal image overlaid with a subtitle, the fourth normal image being a normal image overlaid with a negative subtitle, and the third normal image and the fourth normal image may appear with equal frequency in one frame period, and the sync signal transmitted by the transmitting unit may define that the negative image is displayed while the left-eye shutter and the right-eye shutter are both in the closed status. The present invention provides a viewing method in which, for example, when a plurality of viewers view the same movie on the same screen, one viewer views a dubbed version without wearing glasses, and another viewer views the Japanese subtitle by wearing the glasses.

The above-described generating device may further comprise an audio data transmitting unit configured to transmit, to the glasses, negative audio data that negates audio output from the display device. This structure provides a viewing method in which, for example, a person wearing glasses A can see an image, but not a subtitle, and can hear the Japanese audio from the earphone attached to or paired with the glasses, and a person wearing glasses B can see the image with the subtitle and can hear the English audio from the earphone attached to the glasses B. When viewing the same movie, a child can wear the glasses A to view a dubbed version, and an adult can wear the glasses B to view the Japanese subtitle and hear the English audio. In this way, it is possible to build a viewing environment in which different shutter-type glasses are used in combination to provide different contents of subtitle and audio to two users, of which one is wearing the glasses and the other is not. In particular, the system is expected to evolve into language teaching materials.

### Embodiment 6

The present embodiment provides a viewing environment in which a person, who is not wearing shutter-type glasses or wearing shutter-type glasses that open and close the shutters at timings that do not match the image display timings, cannot see a part or all of an image on screen by the effect of the negative image.

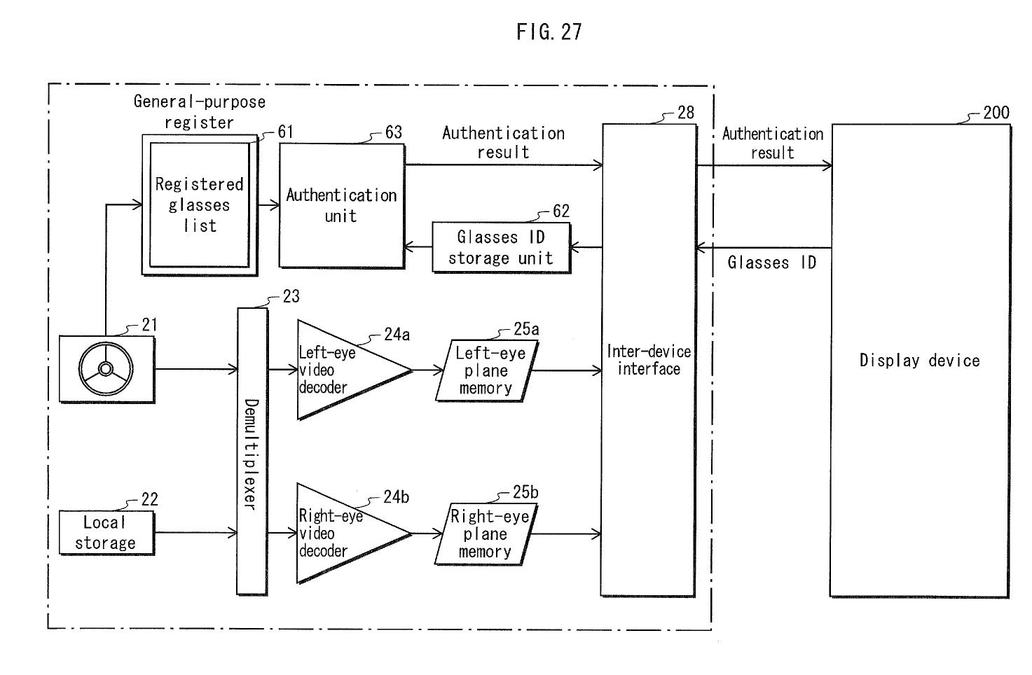

FIG. 27 illustrates the internal structure of the playback device having the improvement unique to the present embodiment. FIG. 27 illustrates the internal structure of the playback device in Embodiment 6. FIG. 27 is drawn based on the internal structure drawing of Embodiment 3, and differs from the structure in Embodiment 3 in that it additionally has an authentication system.

The authentication system of the playback device includes: a general-purpose register 61 for storing a list of registered shutter-type glasses that has been read from the recording medium; a shutter-type glasses ID storage unit 62 storing IDs of shutter-type glasses in the display device; and an authentication unit 63 that performs an authentication of the shutter-type glasses in the display device by using shutter-type glasses ID and the list of registered shutter-type glasses, and when the authentication proves that the shutter-type glasses are authentic, notifies the display device of the authentication result.

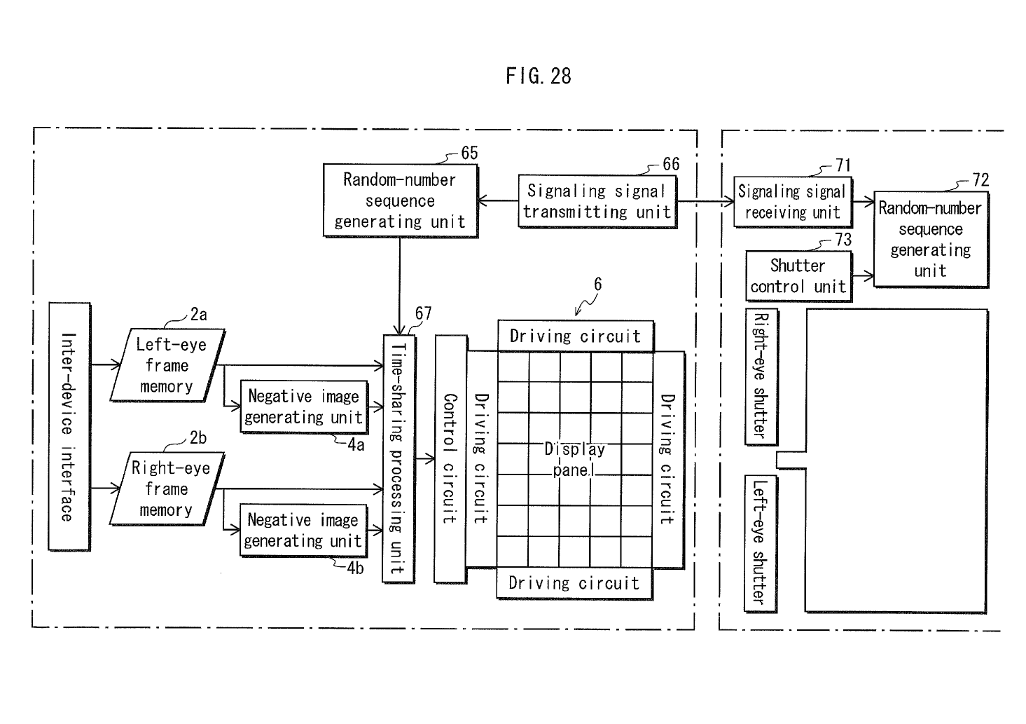

FIG. 28 illustrates the internal structure of the display device. The display device includes a random-number sequence generating unit 65 for generating a random-number sequence which is a type of code sequence, a signaling signal transmitting unit 66 for transmitting a signaling signal, which causes the shutter-type glasses to generate a code sequence, to the shutter-type glasses, and a time-sharing processing unit 67 for executing switching between the normal image and the negative image in accordance with each code word contained in the generated code sequence.

The shutter-type glasses in Embodiment 6 includes a signaling signal receiving unit 71 for receiving a signaling signal, a random-number sequence generating unit 72 for generating a code sequence in accordance with the received signal, and a shutter control unit 73 for controlling the opening/closing of the left-eye and right-eye shutters in accordance with the code word in the generated code sequence.

The code sequences generated by the random-number sequence generating units 65 and 72 have the same regularity as the code sequence in the shutter-type glasses. When the shutter control unit of the shutter-type glasses performs opening/closing of the shutters in accordance with the code sequence that starts to be generated by the signaling signal, a user wearing the shutter-type glasses can view the normal and negative images that are displayed in accordance with the code sequence in the display device.

The following describes what code sequences are generated by the display device and the shutter-type glasses of the present embodiment. The code sequences generated are PE-modulated bit sequences. A PE-modulated bit sequence is a bit sequence obtained by PE (Phase Encode)-modulating a bit sequence that constitutes an M-sequence random number. The M-sequence random number is a pseudo random-number sequence whose one cycle is as long as the longest bit sequence that can be generated by a primitive polynomial, and has a property that the probability of having a continuation of either “0” or “1” is low.

On the other hand, a phase modulation is a modulation that replaces a bit value “0” in the M-sequence random number with a two-bit value “10”, and a bit value “1” with a two-bit value “01”. Thus this modulation allows 50/50 “0”s and “1”s to appear in the random number bit sequence. Since the bit values “0” and “1” in the random-number sequence are assigned to the shutter opened and closed statuses, respectively, the probability for the opened status to appear and the probability for the closed status to appear in one frame period are equivalent.

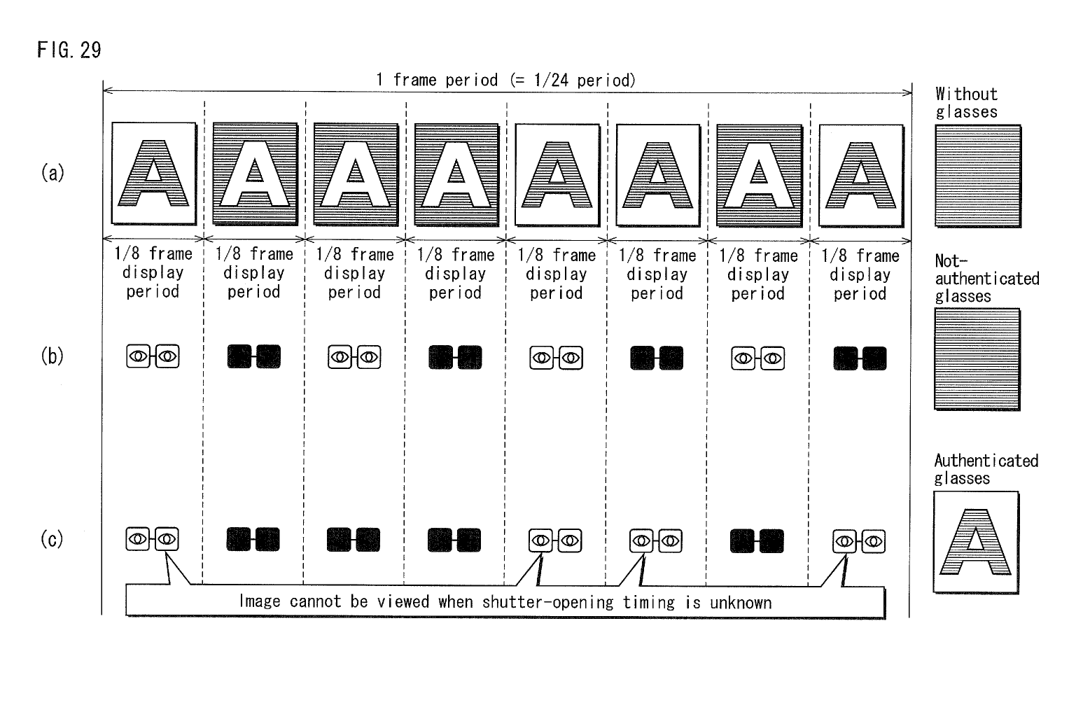

FIG. 29 illustrates that normal images and negative images of image A are displayed in sequence in accordance with a code sequence. The portion (a) of FIG. 29 indicates that a normal image A, a negative image A, a negative image A, a negative image A, a normal image A, a normal image A, a negative image A, and a normal image A are displayed in respective eight ⅛ frames obtained by division of one frame, by time sharing. When these normal images and negative images are displayed simultaneously, the images are totally erased. As illustrated in FIG. 29, a person not wearing the shutter-type glasses can only see an image having no grayscale but cannot recognize the normal images since the normal images are negated by the negative images as they are overlaid with each other, as described so far.

The portion (b) of FIG. 29 indicates viewing through not-authenticated shutter-type glasses. The not-authenticated shutter-type glasses open and close the shutters independently of the output of the normal images and negative images. As illustrated in the portion (b) of FIG. 29, when a person views the screen of the display device through shutter-type glasses whose opening/closing pattern does not match the normal image displaying timing, the person can only see an image having no grayscale but cannot recognize the normal images since the person sees the screen on which both the normal images and the negative images are displayed by the time sharing and the normal images are negated by the negative images.

The portion (c) of FIG. 29 indicates the sync control performed on the shutter-type glasses B. Here, the shutter-type glasses B are presumed to be authenticated shutter-type glasses that have been authenticated by the playback device. The example provided in the portion (c) of FIG. 29 indicates that the shutters are opened during the display periods of the first, fifth, sixth, and eighth ⅛ frames, and closed during the display periods of the remaining ⅛ frames. The authenticated shutter-type glasses authenticated by the playback device generate a code sequence that has the same regularity as the code sequence generating unit of the display device, and control the opened/closed status of the left-eye and right-eye shutters in accordance with the generated code sequence. This allows only the image A to be viewed. As described above, in the example provided in FIG. 29, only when the user is wearing shutter-type glasses whose opening/closing pattern matches the normal image display timing, the user can view only the normal image and recognize the normal image correctly because the negative image is not seen. Note that the screen region in which the normal image and the negative image are displayed by time sharing with a same regularity may be limited to a partial region of the screen.

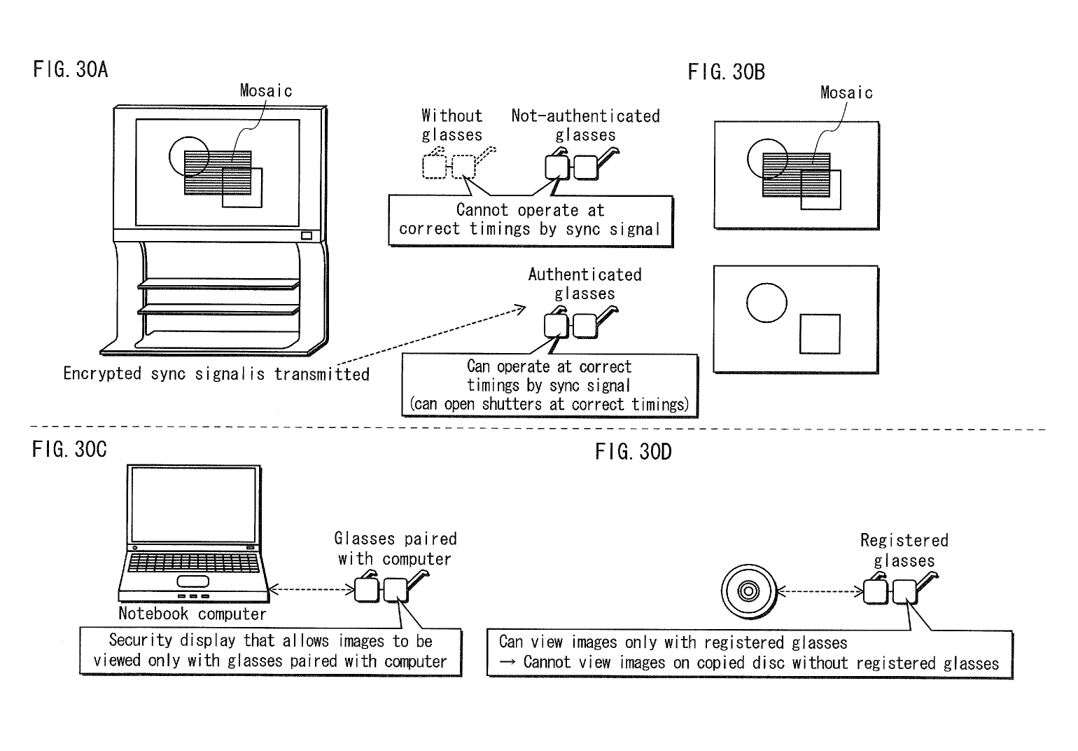

The following describe use cases of the present embodiment as supplemental description of the structural elements in the present embodiment. FIG. 30A illustrates a use case where the negative image is applied to a partial region of the screen. The normal image and the negative image are displayed alternately in a central region of the screen of the display device. This causes a mosaic to be applied to the central region such that a portion of the image displayed at the central region of the screen is covered with the mosaic. FIG. 30A illustrates how the central region is covered with the mosaic. The upper portion of FIG. 30B illustrates an image which is seen by a user who is not wearing shutter-type glasses or a user who is wearing not-authenticated shutter-type glasses. Such a user has no choice but to view an image with a mosaic because the not-authenticated shutter-type glasses do not close the shutters during display periods in which the negative image is displayed. The lower portion of FIG. 30B illustrates an image which is seen by a user who is wearing authenticated shutter-type glasses. The user views only the normal image because the authenticated shutter-type glasses receive the sync signal and close the shutters during display periods in which the negative image is displayed.

The characteristic structural elements of the present embodiment can be applied to a notebook computer and glasses paired with the notebook computer. FIG. 30C illustrates a pair of a notebook computer and shutter-type glasses to which the display device and the shutter-type glasses of the present embodiment are applied. In this case, only the shutter-type glasses paired with the notebook computer enable the user to view the image displayed on the notebook computer. Thus this structure makes it possible to maintain the security of the display device. Also, as illustrated in FIG. 30D, the present embodiment can be applied to anti-piracy measures. More specifically, viewing with shutter-type glasses that are not entered in a list of registered shutter-type glasses recorded on a disc is prohibited. For this purpose, the registered shutter-type glasses list is stored in a special region that is protected from copying. With this structure, only an authorized owner of the disc can view the image. This contributes to enhancement of the anti-piracy measures.

As described above, according to the present embodiment, the playback device performs an authentication, and only shutter-type glasses that have been successfully authenticated generate a code sequence having the same regularity as the display device, and control the opened/closed status of the shutters. With this structure, only the shutter-type glasses that have been successfully authenticated can realize a synchronized display, and shutter-type glasses that have not been successfully authenticated cannot realize the synchronized display. This allows only users who wear authorized shutter-type glasses to view the image. Furthermore, with a structure where a list of registered authorized shutter-type glasses is recorded on a recording medium in advance and a signaling signal for generating a code sequence is transmitted to shutter-type glasses only when it is confirmed that the shutter-type glasses are entered in the list, it is possible to allow only users wearing the authorized shutter-type glasses to view the image.

This structure motivates the user to buy a legitimate optical disc and legitimate shutter-type glasses since the user cannot view a content without wearing shutter-type glasses that are registered in the registered shutter-type glasses list recorded on the optical disc. This contributes to enhancement of the anti-piracy measures.

[Advantageous Effects of Invention]

The invention described in the present embodiment (hereinafter referred to as “present invention”) is obtained by adding the following limitations to the invention of generating device described in Embodiment 1.

That is to say, the generating device being a display device further comprising: a code sequence generating unit configured to generate a code sequence that has regularity common to the glasses and the display device, a displaying unit configured to display the normal image and the negative image in accordance with the code sequence generated by the code sequence generating unit; and a transmitting unit configured to cause the glasses to start controlling opening and closing of shutters in accordance with a code word included in the code sequence, by transmitting a predetermined signaling signal to the glasses. According to this structure, the playback device performs an authentication, and only glasses that have been successfully authenticated generate a code sequence having the same regularity as the display device, and control the opened/closed status of the shutters. With this structure, only the glasses that have been successfully authenticated can realize a synchronized display, and glasses that have not been successfully authenticated cannot realize the synchronized display. This allows only users who wear authorized glasses to view the image. Thus, since an image cannot be viewed if glasses paired with the display device are not worn, it is possible to urge buying the glasses paired with the display devices.

In the above-described generating device, the display device may be connected with a playback device for reading a content from a recording medium and playing back the content, the recording medium storing a list of registered glasses indicating glasses that are permitted to be used to view the content, and when the glasses corresponding to the playback device are authenticated successfully by the playback device by referring to the list of registered glasses, the transmitting unit may transmit the predetermined signaling signal to the glasses.

With this structure where a list of registered authorized glasses is recorded on a recording medium in advance and a signaling signal for generating a code sequence is transmitted to glasses only when it is confirmed that the glasses are entered in the list, it is possible to allow only users wearing the authorized glasses to view the image. This structure motivates the user to buy a legitimate optical disc and legitimate glasses since the user cannot view a content without wearing glasses that are registered in the registered glasses list recorded on the optical disc. This contributes to enhancement of the anti-piracy measures.

As described above, the present invention provides enhancement of the anti-piracy measures from the new perspective of paring glasses and a recording medium, and thus will bring more growth into content production industries such as the movie industry, publishing industry, game industry, and music industry. Such a growth in the content production industries will encourage the domestic industry and strengthen the competitiveness thereof.

### Embodiment 7

The present embodiment relates to reducing errors by expanding the bit width. More specifically, the present embodiment reduces errors that may occur during generation of pixel values for the negative image, by expanding the bit width from eight bits to 12 bits with regards to the luminance Y, red color difference Cr, and blue color difference Cb.

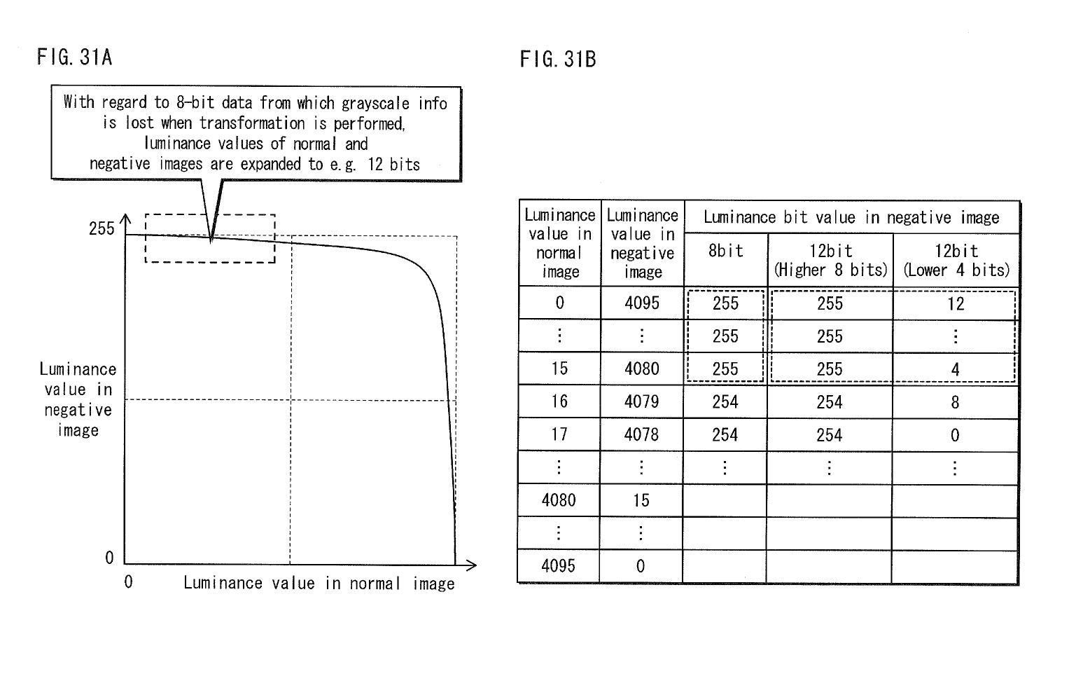

FIGS. 31A and 31B illustrate the concept of reducing errors by expanding the bit width. FIG. 31A is a graph in which the horizontal axis represents the luminance value in the data and the vertical axis represents the luminance value of the negative image. FIG. 31B is a table showing 4096 grayscale levels of luminance of the normal image associated with 4096 grayscale levels of luminance of the negative image, luminance values represented by the higher eight bits of luminance of the negative image, and luminance values represented by the lower four bits of luminance of the negative image. As indicated in the leftmost column of this table, the luminance of the normal image changes in a range from 0 to 4095. In correspondence with this, the luminance of the negative image changes in a range from 4095 to 0.

As described above, the luminance value of the negative image needs to be deviated toward higher value of luminance. In that case, when each luminance value of the normal image is represented by eight bits, some different luminance values of the normal image are represented as a same luminance value of the negative image, which occurs due to the difference in the range of values, and the grayscale levels cannot be represented correctly. In the case of the example provided in FIGS. 31A and 31B, a luminance range enclosed by a dotted line (a range from 4080 to 4095 of luminance values of the negative image) is a portion of different luminance values in the normal image that are represented as a same value in the eight-bit representation. That is to say, when each of the 4096 grayscale levels of luminance of the normal image is represented by eight bits, the values in the range from 4080 to 4095 of luminance values of the normal image are all represented as same luminance value “255” in the eight-bit representation.

In the present embodiment, the above-described problem is solved by, when the normal image is created, a 12-bit value, expanded from an 8-bit value, is assigned to each pixel as representing the grayscale level of the luminance of the normal image. Also, the negative image generating unit transforms a 12-bit luminance value to a pixel bit value of the negative image, taking account of the screen mode and the screen size. In that case, luminance values 1 to 15 of the normal image are represented as 255 by the higher eight bits and 12 to 4 by the lower four bits of the luminance value of the negative image. This allows for representation of luminance values of the negative image ranging from 4080 to 4095 correctly.

In this way, when the luminance value of the negative image needs to be deviated toward higher value of luminance relative to the positive image, the luminance values of the negative image ranging from 4095 to 4080 are represented correctly. As described above, it is possible to eliminate an error that would occur during the bit conversion, by representing the luminance data of the normal image by 12-bit values, and transforming the 12-bit luminance values to the luminance data of the negative image.

<Supplementary Notes>

Up to now, the present invention has been described through the best embodiments that the Applicant recognizes as of the application of the present application. However, further improvements or changes can be added regarding the following technical topics. Whether to select any of the embodiments or the improvements and changes to implement the invention is optional and may be determined by the subjectivity of the implementer.

(Variations of Glasses for Viewing Normal and Negative Images)

In the above embodiments, shutter-type glasses are used as the glasses for viewing the normal and negative images. However, not limited to these, glasses other than the shutter type may be used as far as the glasses can select one or more images from among a plurality of images displayed by time sharing, and can provide the selected images to the user's viewing. More specifically, polarized glasses may be adopted on the condition that they have an optical mechanism which prevents, among the normal image and the negative image, only the negative image from being viewed.

(Embodiment as Mobile Terminal)

The display device may be implemented as a mobile device having a function to capture a stereoscopic image. In this case, the mobile device includes an image-capturing unit, stores left-eye image data and right-eye image data obtained by the image-capturing unit into an image file, and writes the image file onto a recording medium. On the other hand, the mobile terminal extracts compressed left-eye image data and compressed right-eye image data from the image file, and outputs the extracted data for a playback. One example of the stereoscopic image file is an MPO file. The MPO (Multi Picture Object) file can store an image captured by “3DS” manufactured by Nintendo Co., Ltd., or “FinePix REAL 3D W1 or W3” camera manufactured by Fujifilm Corporation. The MPO file contains image capture date, size, compressed left-eye image data, and compressed right-eye image data, and also contains, as geographical information of the location where the image was captured, the latitude, longitude, altitude, direction, and tilt. The compressed left-eye image data and compressed right-eye image data are data compressed in the JPEG format. Thus the mobile terminal obtains a left-eye image and a right-eye image by expanding the JPEG-format data. A negative image is then generated for the left-eye image and right-eye image thus obtained. In this way, it is possible to realize, on the mobile terminal, the processes described in Embodiment 1.

(Embodiment as TV Broadcast Receiver)

In the above embodiments, the internal structure of a simple display device is disclosed. To be used as a TV broadcast receiver, the display device needs to additionally include a service receiving unit, a separating unit, and a display determining unit.

The service receiving unit manages selection of services. More specifically, upon receiving a user instruction via a remote control signal or a service change request instructed by an application, the service receiving unit notifies the receiving unit of the received instruction or request.

The receiving unit receives, via an antenna or a cable, a signal at a frequency of a carrier wave of a transport stream which distributes the selected service, and demodulates the received transport stream. The demodulated transport stream is sent to the separating unit.

The receiving unit includes a tuner unit for performing an IQ detection onto a received broadcast wave, a demodulating unit for performing QPSK demodulation, VSB demodulation, or QAM demodulation onto the broadcast wave having gone through the IQ detection, and a transport decoder.

The display determining unit refers to each of 3D_system_info_descriptor, 3D_service_info_descriptor, and 3D_combi_info_descriptor that are notified from the demultiplexing unit, and grasps the stream configuration of the transport stream. The display determining unit then notifies the demultiplexing unit of the PID of a TS packet that is to be demultiplexed in the current screen mode.

Also, when the stereoscopic playback system adopted is the frame compatible system, the display determining unit refers to 2D_view_flag of 3D_system_info_descriptor or frame_packing_arrangement_type of 3D_service_info_descriptor, and notifies the display processing unit which of the left-eye image and the right-eye image is used in the 2D playback, whether the video stream is the side-by-side system, and the like. The display determining unit determines the playback system of the received transport stream by referring to 3D_playback_type of 3D_system_info_descriptor extracted by the demultiplexing unit. When the playback system is the service compatible system, the display determining unit refers to 2D_independent_flag of 3D_system_info_descriptor and judges whether or not a same video stream is shared by 2D playback and 3D playback.

When the value of 2D_independent_flag is 0, the display determining unit refers to 3D_combi_info_descriptor to identify the stream configuration. When the stream configuration of the transport stream is 2D/L+R1+R2, the display determining unit obtains a set of left-eye image data and right-eye image data by decoding the streams of 2D/L+R1+R2.

When the stream configuration of the transport stream is 2D/L+R, the display determining unit obtains a set of left-eye image data and right-eye image data by decoding the streams of 2D/L+R.

When the value of 2D_independent_flag is 1, the display determining unit refers to 3D_combi_info_descriptor to identify the stream configuration. When the stream configuration of the transport stream is MPEG2+MVC (Base)+MVC (Dependent), the display determining unit obtains a set of left-eye image data and right-eye image data by decoding the streams of MPEG2+MVC (Base)+MVC (Dependent).

When the stream configuration of the transport stream is MPEG2+AVC+AVC, the display determining unit obtains a set of left-eye image data and right-eye image data by decoding the streams of MPEG2+AVC+AVC.

When the playback system is the frame compatible system, the display determining unit refers to 2D_independent_flag of 3D_system_info_descriptor and judges whether or not a same video stream is shared by 2D playback and 3D playback. When the value of 2D_independent_flag is 0, the display determining unit obtains a set of left-eye image data and right-eye image data by decoding the streams of 2D/SBS.

When the value of 2D_independent_flag is 1, the display determining unit obtains a set of left-eye image data and right-eye image data by decoding the streams of 2D+SBS. When frame_packing_arrangement_type indicates the side-by-side system, the 3D playback is carried out by cropping out the leftmost and rightmost portions of the left-eye and right-eye images. When frame_packing_arrangement_type indicates other than the side-by-side system, the system is identified as the TopBottom system, and the 3D playback is carried out by cropping out the uppermost and lowermost portions of the left-eye and right-eye images.

The left-eye image data and right-eye image data are obtained by decoding the video stream in accordance with the stream configuration identified through the above determination process.

As described above, a normal image may be obtained by demodulating or decoding a TV broadcast wave, and a negative image that negates the normal image may be created.

(Embodiment of Integrated Circuit)

Among the hardware components of the display device, playback device and shutter-type glasses described in the embodiments, hardware components which correspond to logic circuits and storage elements, namely, the core of logic circuits excluding a mechanical part composed of the drive unit of the recording medium, connectors to external devices, and the like, may be realized as a system LSI. The system LSI is obtained by implementing a bare chip on a high-density substrate and packaging them. The system LSI is also obtained by implementing a plurality of bare chips on a high-density substrate and packaging them, so that the plurality of bare chips have an outer appearance of one LSI (such a system LSI is called a multi-chip module).

The system LSI has a QFP (Quad Flat Package) type and a PGA (Pin Grid Array) type. In the QFP-type system LSI, pins are attached to the four sides of the package. In the PGA-type system LSI, a lot of pins are attached to the entire bottom.

These pins function as a power supply, ground, and an interface with other circuits. The system LSI, which is connected with other circuits through such pins as an interface, plays a role as the core of the playback device.

(Embodiments of Program)

The program described in each embodiment of the present invention can be produced as follows. First, the software developer writes, using a programming language, a source program that achieves each flowchart and functional component. In this writing, the software developer uses the class structure, variables, array variables, calls to external functions, and so on, which conform to the sentence structure of the programming language he/she uses.

The written source program is sent to the compiler as files. The compiler translates the source program and generates an object program.

The translation performed by the compiler includes processes such as the syntax analysis, optimization, resource allocation, and code generation. In the syntax analysis, the characters and phrases, sentence structure, and meaning of the source program are analyzed and the source program is converted into an intermediate program. In the optimization, the intermediate program is subjected to such processes as the basic block setting, control flow analysis, and data flow analysis. In the resource allocation, to adapt to the instruction sets of the target processor, the variables in the intermediate program are allocated to the register or memory of the target processor. In the code generation, each intermediate instruction in the intermediate program is converted into a program code, and an object program is obtained.

The generated object program is composed of one or more program codes that cause the computer to execute each step in the flowchart or each procedure of the functional components. There are various types of program codes such as the native code of the processor, and Java™ byte code. There are also various forms of realizing the steps of the program codes. For example, when each step can be realized by using an external function, the call statements for calling the external functions are used as the program codes. Program codes that realize one step may belong to different object programs. In the RISC processor in which the types of instructions are limited, each step of flowcharts may be realized by combining arithmetic operation instructions, logical operation instructions, branch instructions and the like.

After the object program is generated, the programmer activates a linker. The linker allocates the memory spaces to the object programs and the related library programs, and links them together to generate a load module. The generated load module is based on the presumption that it is read by the computer and causes the computer to execute the procedures indicated in the flowcharts and the procedures of the functional components. The computer program described here may be recorded onto a non-transitory computer-readable recording medium, and may be provided to the user in this form.

### INDUSTRIAL APPLICABILITY

The present invention provides various viewing forms including 3D viewing with use of a display device and shutter-type glasses that can control display timing, which is expected to stimulate the commercial equipment market. Thus the display device and method of the present invention are highly usable in the image content industry and commercial equipment industry.

### REFERENCE SIGNS LIST

100 playback device
101 optical disc
102 remote control
103 shutter-type glasses
200 display device

1. A generating device for generating images to be viewed by a user wearing glasses, comprising:
an obtaining unit configured to obtain a normal image; and
a generating unit configured to generate a negative image that negates the obtained normal image, wherein
the glasses, when worn by the user, allow the user to view one or more of a plurality of images displayed by a time sharing in a frame period of an image signal,
the normal image and the negative image are displayed by the time sharing, and
for each pair of a pixel included in the negative image and a pixel included in the normal image that correspond to each other, a luminance of a pixel in the negative image is set to a value greater than a difference obtained by subtracting a luminance of a corresponding pixel in the normal image from a maximum value in a range of luminance values that can be taken by each pixel.

2. The generating device of claim 1, wherein
the glasses are shutter-type glasses, and
the generating device is a display device and further comprises:
a displaying unit configured to display the normal image and the negative image in one frame period by the time sharing; and
a transmitting unit configured to transmit a sync signal defining whether a left-eye shutter of the glasses is in an opened status or a closed status and whether a right-eye shutter the glasses is in the opened status or the closed status, when a display of the normal image or the negative image is started.

3. The generating device of claim 2, wherein
the normal image includes a first normal image and a second normal image, the first normal image being an image for users who wear the glasses, the second normal image being an image for users who do not wear the glasses,
the first normal image and the negative image appear with equal frequency in one frame period, and
the sync signal transmitted by the transmitting unit defines that the negative image is displayed while the left-eye shutter and the right-eye shutter are both in the closed status.

4. The generating device of claim 2, wherein
the normal image includes a third normal image and a fourth normal image, the third normal image being a normal image overlaid with a subtitle, the fourth normal image being a normal image overlaid with a negative subtitle,
the third normal image and the fourth normal image appear with equal frequency in one frame period, and
the sync signal transmitted by the transmitting unit defines that the negative image is displayed while the left-eye shutter and the right-eye shutter are both in the closed status.

5. The generating device of claim 4 further comprising
an audio data transmitting unit configured to transmit, to the glasses, negative audio data that negates audio output from the display device.

6. The generating device of claim 1 being a display device further comprising:
a code sequence generating unit configured to generate a code sequence that has regularity common to the glasses and the display device,
a displaying unit configured to display the normal image and the negative image in accordance with the code sequence generated by the code sequence generating unit; and
a transmitting unit configured to cause the glasses to start controlling opening and closing of shutters in accordance with a code word included in the code sequence, by transmitting a predetermined signaling signal to the glasses.

7. The generating device of claim 6, wherein
the display device is connected with a playback device for reading a content from a recording medium and playing back the content, the recording medium storing a list of registered glasses indicating glasses that are permitted to be used to view the content, and
when the glasses corresponding to the playback device are authenticated successfully by the playback device by referring to the list of registered glasses, the transmitting unit transmits the predetermined signaling signal to the glasses.

8. The generating device of claim 1 being a playback device further comprising:
a reading unit configured to read a transformation equation reference table from a recording medium, the transformation equation reference table showing correspondence between a plurality of transformation equations and a plurality of combinations of a screen size and a screen mode, and
the generating unit extracts, from the transformation equation reference table, a transformation equation corresponding to a combination of a screen size and a screen mode of a connected display device, and generates a negative image by using the extracted transformation equation.

9. Glasses worn by a user during viewing of an image displayed on a display device, the glasses comprising:
a selecting unit configured to select one or more images from among a plurality of images displayed by a time sharing in a frame period of an image signal,
images displayed on the display device are classified into a normal image and a negative image,
the normal image and the negative image are displayed by the time sharing, and
for each pair of a pixel included in the negative image and a pixel included in the normal image that correspond to each other, a luminance of a pixel in the negative image is set to a value greater than a difference obtained by subtracting a luminance of a corresponding pixel in the normal image from a maximum value in a range of luminance values that can be taken by each pixel.
